(19) United States
(12) Patent Application Publication
(10) Pub. No.: US 2026/0226573 A1
(43) Pub. Date: Aug. 6, 2026

(54) STEEL SHEET AND METHOD FOR PRODUCING SAME

(71) Applicant: NIPPON STEEL CORPORATION, Tokyo (JP)

(72) Inventors: Takafumi YOKOYAMA, Tokyo (JP); Taku MIYAKAWA, Tokyo (JP)

(73) Assignee: NIPPON STEEL CORPORATION, Tokyo (JP)

(21) Appl. No.: 19/151,564

(22) PCT Filed: Nov. 7, 2023
(86) PCT No.: PCT/JP2023/040054

§ 371 Date: Jul. 28, 2025

(30) Foreign Application Priority Data
Feb. 22, 2023 (JP) 2023-026489
Feb. 22, 2023 (JP) 2023-026491
Feb. 22, 2023 (JP) 2023-026531

(51) Int. Cl. C21D 8/0247; B32B 15/01; C21D 1/18; C21D 1/74; C21D 6/00; C21D 8/0221; C21D 8/0278; C21D 9/46; C22C 38/00; C22C 38/02; C22C 38/04; C22C 38/06; C22C 38/08; C22C 38/10; C22C 38/12; C22C 38/14; C22C 38/16; C22C 38/22; C22C 38/24; C22C 38/28; C22C 38/32; C22C 38/38; C22C 38/60

(52) U.S. Cl. CPC C21D 8/0257; B32B 15/013; C21D 1/18; C21D 1/74; C21D 6/001; C21D 6/002; C21D 6/005; C21D 6/007; C21D 6/008; C21D 8/0226; C21D 8/0236; C21D 8/0263; C21D 8/0278; C21D 9/46; C22C 38/001; C22C 38/002; C22C 38/005; C22C 38/008; C22C 38/02; C22C 38/04; C22C 38/06; C22C 38/08; C22C 38/10; C22C 38/12; C22C 38/14; C22C 38/16; C22C 38/22; C22C 38/24; C22C 38/28; C22C 38/32; C22C 38/38; C22C 38/60; B32B 2250/02; B32B 2311/20; B32B 2311/30; C21D 2211/001; C21D 2211/002; C21D 2211/003; C21D 2211/005; C21D 2211/008; C21D 2211/009

(57) ABSTRACT

The present invention provides a steel sheet having an improved bendability post-plastic working, and also provides a method for producing this steel sheet. The steel sheet according to the present invention has a tensile strength of at least 980 MPa; has a prescribed chemical composition and a prescribed microstructure; and has, in the surface layer region of the steel sheet, a deboronized layer in which the B emission intensities B30, B140, and B150—according to measurement in the depth direction from the steel sheet surface by radio frequency glow discharge optical emission spectroscopy at depth positions of 30 μm, 140 μm, and 150 μm from the steel sheet surface—satisfy B30/B150<0.90 and 0.90≤B140/B150≤1.10. In addition, the C emission intensities C30, C140, and C150 for the surface layer region of the steel sheet—according to measurement in the depth direction from the steel sheet surface by radio frequency glow discharge optical emission spectroscopy at depth positions of 30 μm, 140 μm, and 150 μm from the steel sheet surface—satisfy C30/C150≤0.5 and 0.90≤C140/C150≤1.10.

### FIELD

The present invention relates to steel sheet and a method of production thereof.

### BACKGROUND

In recent years, improvement of the fuel economy of automobiles has been sought from the viewpoint of restrictions on emission of hothouse effect gases accompanying measures against global warming. High strength steel sheet is being increasingly used for lightening the weight of car bodies and securing safety in collision. In particular, recently, the need for ultra-high strength steel sheet with a tensile strength of 980 MPa or more has been rising.

Steel sheet used for automobile parts is being asked to be improved in not only strength, but also press formability, weldability, and various other aspects of workability required for forming parts. Specifically, excellent elongation (total elongation in tensile test: E1) is being sought from steel sheet from the viewpoint of press formability.

In general, along with the higher strength of steel sheet, the press-formability deteriorates. As a means for achieving both higher strength of steel and press-formability, a TRIP (TRansformation Induced Plasticity) steel sheet utilizing the transformation induced plasticity of retained austenite is known.

PTLs 1 to 3 disclose high strength TRIP steel sheet improved in elongation and hole expandability by controlling the fractions of structural constituents to predetermined ranges. Further, PTL 4 describes high strength steel sheet having a predetermined chemical composition, containing ferrite with an average grain size of 2 μm or less in a volume fraction of 15% or less, retained austenite with an average grain size of 2 μm or less in a volume fraction of 2 to 15%, martensite with an average grain size of 3 μm or less in a volume fraction of 10% or less, and a balance of bainite and tempered martensite with an average grain size of 6 μm or less, and containing an average of 10 or more cementite particles with a particle size of 0.04 μm or more in the bainite and tempered martensite grains and describes that this high strength steel sheet has a 1180 MPa or more tensile strength and has a high elongation and hole expandability and accompanying excellent bendability.

PTL 5 discloses TRIP steel sheet improved in elongation and stretch flangeability by limiting the area ratio of blocky (low aspect ratio) retained austenite.

PTL 6 discloses high strength TRIP steel sheet having a large amount of work hardening at an initial stage of shaping and having excellent shape freezeability and workability by controlling the amount of solid solution Si and amount of solid solution Mn contained in retained austenite to predetermined values or more.

Further, steel sheet for automotive use is asked to be excellent in weldability in addition to press-formability. In particular, in welding of hot dip galvanized steel sheets with each other or welding of a hot dip galvanized steel sheet and a nonplated steel sheet, liquid metal embrittlement (LME) cracking has to be suppressed. This phenomenon is cracking occurring due to the action of tensile stress generated due to welding at a location where zinc rendered a liquid phase due to the input welding heating infiltrates the steel sheet along the grain boundaries to cause embrittlement.

The fact that such LME cracking more easily occurs the higher the content of Si in the steel is disclosed in PTL 7. Therefore, this literature discloses TRIP steel sheet to which, instead of part of the Si added for obtaining retained austenite in TRIP steel, Al having a similar effect is added. Further, TRIP steel sheet to which Al is added in place of part of the Si is also disclosed in PTLs 8 and 9.

Further, PTL 10 discloses a method of production of hot dip galvanized steel sheet excellent in LME cracking resistance characterized by controlling the atmosphere at the time of heat-annealing by heating on a hot dip galvanization line.

Further, the high strength steel sheet used for automobile parts is asked to not fracture due to deformation upon collision after being shaped into parts. In particular, steel sheet used for automobile parts has to be excellent not in bendability before press-forming, but bendability after plastic strain is introduced by press-forming. As inventions improving the bendability of steel sheet for automobile use, there are PTLs 11, 12, 13, and 14 shown below.

PTL 11 discloses steel sheet improved in bendability having B mainly contained in the precipitated state at the steel sheet surface layer part and mainly contained in a solid solution state inside the steel sheet.

PTL 12 discloses high strength steel sheet excellent in delayed fracture resistance of a cut end face and steel sheet base material having a martensite single phase structure, having a region with a KAM value (kernel average misorientation value) of a value of 1° or more comprising 50% or more of the total, and having a maximum tensile residual stress in the surface layer region down to the ¼ depth position of sheet thickness from the surface of 80 MPa or less.

As art for the improvement of the bendability of high strength steel sheet, for example, PTL 13 describes high strength cold rolled steel sheet with a surface layer part mainly comprised of ferrite which is produced by decarburization of the steel sheet. Further, PTL 14 describes ultra-high strength cold rolled steel sheet having a soft layer at the surface layer part which is produced by annealing for decarburization of steel sheet.

### CITATION LIST

### Patent Literature

PATENT LITERATURE 1: WO2013/051238
PATENT LITERATURE 2: Japanese Unexamined Patent Publication No. 2006-104532
PATENT LITERATURE 3: Japanese Unexamined Patent Publication No. 2011-184757
PATENT LITERATURE 4: WO2017/179372
PATENT LITERATURE 5: WO2018/190416
PATENT LITERATURE 6: WO2013/018741
PATENT LITERATURE 7: WO2018/202916
PATENT LITERATURE 8: Japanese Unexamined Patent Publication No. 2011-17046
PATENT LITERATURE 9: WO2013/144377
PATENT LITERATURE 10: WO2018/234938
PATENT LITERATURE 11: WO2017/002883
PATENT LITERATURE 12: Japanese Unexamined Patent Publication No. 2015-155572
PATENT LITERATURE 13: Japanese Unexamined Patent Publication No. 10-130782
PATENT LITERATURE 14: Japanese Unexamined Patent Publication No. 5-195149

### SUMMARY

### Technical Field

However, improvement of the bendability after plastic strain is introduced has not necessarily been sufficiently studied up to now.

Therefore, the present invention has as its object the provision of steel sheet excellent in tensile strength and improved in elongation (EL), liquid metal embrittlement (LME) cracking resistance, and bendability after plastic working and a method of production thereof.

### Solution to Problem

The inventors engaged in repeated intensive studies for solving the above problem and as a result discovered that it is possible to improve the elongation (EL), liquid metal embrittlement (LME) cracking resistance, and bendability after plastic working for steel sheet including retained austenite by forming a suitable deboronized layer and decarburized layer at the surface layer part, that is, by forming a suitable decarburized deboronized layer. The present invention was perfected based on these findings and includes the following aspects.

### Aspect 1

Steel sheet, in which steel sheet,
a chemical composition of the steel sheet contains, by mass %,
C: 0.15 to 0.35%,
Si: 0.01 to 1.20%,
Mn: 1.00 to 3.50%,
Al: 0.300 to 1.500%,
Ti: 0.001 to 0.100%,
B: 0.0005 to 0.0050%,
P: 0.050% or less,
S: 0.0100% or less,
N: 0.010% or less,
O: 0.0100% or less,
Cr: 0 to 1.00%,
Mo: 0 to 1.00%,
Cu: 0 to 1.00%,
Ni: 0 to 1.00%,
Co: 0 to 1.00%,
W: 0 to 1.00%,
Sn: 0 to 1.00%,
Sb: 0 to 0.50%,
Nb: 0 to 0.200%,
V: 0 to 1.00%,
As: 0 to 0.10%,
Zn: 0 to 1.00%,
Ca: 0 to 0.0100%,
Mg: 0 to 0.0100%,
Zr: 0 to 0.0100%,
Hf: 0 to 0.0100%,
Bi 0 to 0.0100%,
REM: 0 to 0.015%, and
bal.: Fe and impurities,
a microstructure in a range of a ⅛ depth position to ⅜ depth position of sheet thickness of the steel sheet comprises, by area %,
ferrite: 0 to 50%,
retained austenite: 6 to 30%,
total of fresh martensite and cementite: 0 to 10%,
pearlite: 5% or less,
tempered martensite: 5% or more, and
bal.: bainite,
a surface layer part of the steel sheet has a deboronized layer with an emission intensity of B, measured by high frequency glow discharge spectrometry in a depth direction from the steel sheet surface, satisfying the following formula (1) and formula (2),
further, a surface layer part of the steel sheet has an emission intensity of C, measured by high frequency glow discharge spectrometry in a depth direction from the steel sheet surface, satisfying the following formula (3) and formula (4), and
a tensile strength is 980 MPa or more:

$$B 30 / B 150 < 0 \text{.90} \qquad ( 1 )$$

$$0.9 \leq B 140 / B 150 \leq 1 \text{.10} \qquad ( 2 )$$

$$C 30 / C 150 \leq 0 \text{.50} \qquad ( 3 )$$

$$0.9 \leq C 140 / C 150 \leq 1 \text{.10} \qquad ( 4 )$$

where,
B30: emission intensity of B at depth position of 30 μm from the steel sheet surface
B140: emission intensity of B at depth position of 140 μm from the steel sheet surface
B150: emission intensity of B at depth position of 150 μm from the steel sheet surface
C30: emission intensity of C at depth position of 30 μm from the steel sheet surface
C140: emission intensity of C at depth position of 140 μm from the steel sheet surface
C150: emission intensity of C at depth position of 150 μm from the steel sheet surface

### Aspect 2

The steel sheet according to the aspect 1, wherein the steel sheet surface has a hot dip galvanized layer or a hot dip galvannealed layer.

### Aspect 3

A method of production of steel sheet, which method of production of steel sheet comprising
a hot rolling step (a) of hot rolling a slab having a chemical composition comprising, by mass %,
C: 0.15 to 0.35%,
Si: 0.01 to 1.20%,
Mn: 1.00 to 3.50%,
Al: 0.300 to 1.500%,
Ti: 0.001 to 0.100%,
B: 0.0005 to 0.0050%,
P: 0.050% or less,
S: 0.0100% or less,
N: 0.010% or less,
O: 0.0100% or less,
Cr: 0 to 1.00%,
Mo: 0 to 1.00%,
Cu: 0 to 1.00%,
Ni: 0 to 1.00%,
Co: 0 to 1.00%,
W: 0 to 1.00%,
Sn: 0 to 1.00%,
Sb: 0 to 0.50%,
Nb: 0 to 0.200%,
V: 0 to 1.00%,
As: 0 to 0.10%,
Zn: 0 to 1.00%,
Ca: 0 to 0.0100%,
Mg: 0 to 0.0100%,
Zr: 0 to 0.0100%,
Hf: 0 to 0.0100%,
Bi: 0 to 0.0100%,
REM: 0 to 0.015%, and
bal.: Fe and impurities at a 850 to 950° C. finish rolling end temperature to obtain hot rolled steel sheet, then cooling the hot rolled steel sheet down to 450 to 680° C. and coiling the hot rolled steel sheet,
a pickling step (b) of pickling the steel sheet obtained at the hot rolling step (a),
a cold rolling step (c) of cold rolling the steel sheet obtained by the pickling step (b) by a 30 to 75% rolling reduction to obtain a cold rolled steel sheet,
a heat treatment step (d) of heat treating the steel sheet obtained at the cold rolling step (c), and
a grinding step (e), before or after the pickling step (b), of using a rotary type grinding brush containing an abrasive to grind the front and back surfaces of the steel sheet obtained at the hot rolling step (a) or the steel sheet obtained at the pickling step (b),
in the hot rolling step (a), finish rolling comprises three passes or more, the rolling reduction of the respective passes of the final three passes of the finish rolling is 20% or more, the time between passes is within 1 second, the entry side steel sheet temperature before the final three passes is 1000° C. or less, and the time from the completion of the final pass to the start of cooling is within 3 seconds,
in the grinding step (e), a rotational speed R (rpm) of the grinding brush, a diameter D (m) of the grinding brush, and a running speed V (m/min) of the steel sheet satisfy the following formula (5),
the heat treatment step (d) further provided with
a step (d-1) of heating the steel sheet obtained at the cold rolling step (c) from 650° C. to a maximum heating temperature of the Ac1+50° C. or more and 950° C. or less by a 0.5 to 500° C./s average heating speed,
a step (d-2) of holding the steel sheet obtained at the cold rolling step (c) at the maximum heating temperature for 1 second to 300 seconds,
a step (d-3) of cooling the steel sheet obtained at the cold rolling step (c) down to the Ms point −30° C. or less, at which step, cooling from 700° C. to 500° C. by a 10° C./s or more average cooling speed, and
a step (d-4) of holding the steel sheet obtained at the cold rolling step (c) at 300 to 450° C. for 100 to 600 seconds,
at step (d-1), the atmosphere in the surroundings of the steel sheet obtained at the cold rolling step (c) having a steam partial pressure pH₂O and hydrogen partial pressure pH₂ satisfying the following formula (6):

$$[ Mathematical 1 ]$$

$$\frac{R \cdot D}{V} > 10 \qquad ( 5 )$$

$$- 1. \leq log ( {pH}_{2} O / {pH}_{2} ) \leq - 0.1 \qquad ( 6 )$$

### Aspect 4

The method of production of steel sheet according to the aspect 3, wherein
the hot rolling step (a) further comprises a step of retaining the heat of the hot rolled steel sheet after coiling within 30 minutes in a heat insulating vessel with inside walls covered by a heat insulating material, wherein
a peak temperature of an atmospheric temperature inside of the heat insulating vessel is 500 to 650° C., and the time from the atmospheric temperature to the peak temperature is 1 to 8 hours.

### Advantageous Effects of Invention

According to the present invention, it is possible to obtain steel sheet excellent in tensile strength and excellent in elongation (EL), LME cracking resistance, and bendability after plastic working.

### BRIEF DESCRIPTION OF DRAWINGS

FIG. 1 is a view schematically showing a cross-section of a plated steel sheet 1 including a base steel sheet 2 according to one embodiment of the present invention sliced in the sheet thickness direction.

### DESCRIPTION OF EMBODIMENTS

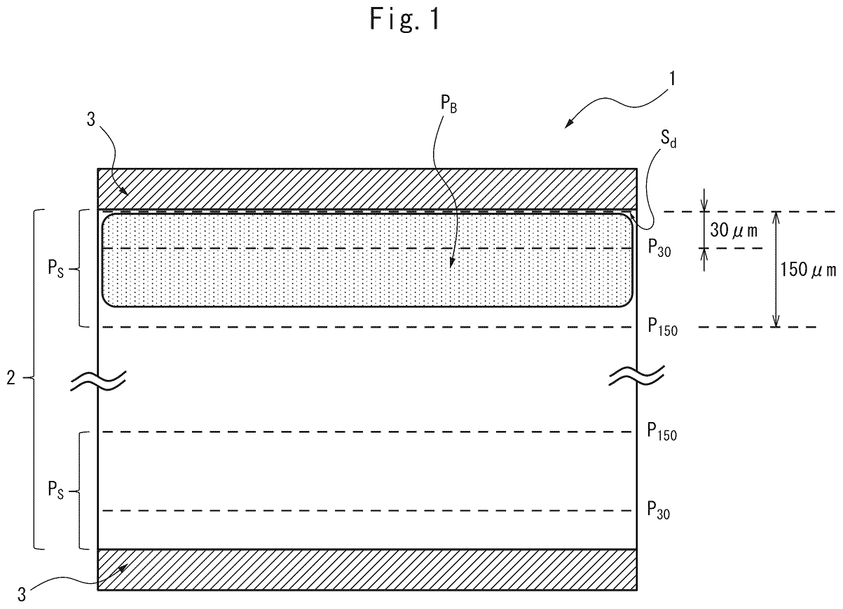

Below, a plated steel sheet including a steel sheet of one embodiment of the present invention as a base steel sheet will be explained in detail while referring to FIG. 1. It should be noted that, FIG. 1 is a view schematically showing a cross-section of a plated steel sheet 1 including a base steel sheet 2 according to one embodiment of the present invention sliced in the sheet thickness direction.

The present invention prescribes the features of a specific position of the steel sheet in the sheet thickness direction. In the following explanation, these features will sometimes be explained using a position of the steel sheet in the sheet thickness direction based on the steel sheet surface.

It should be noted that, the “sheet thickness direction” and the “depth direction” of the steel sheet are synonymous, and therefore in this Description, a position of the steel sheet in the sheet thickness direction based on the steel sheet surface will sometimes be called the “depth position”.

In relation to this, in this Description, the “x/y depth position of sheet thickness (in this case, ‘x’ and ‘y’ are natural numbers satisfying x<y)” means the position in the sheet thickness direction of the steel sheet from the surface, that is, the steel sheet surface, in the sheet thickness direction toward the center part of the steel sheet by exactly the distance of x/y of the sheet thickness (depth). For example, if the sheet thickness of the steel sheet was “t” mm, the “⅛ depth position of the sheet thickness” means the position becoming the depth of 1t/8 mm in the sheet thickness direction from the steel sheet surface.

In this case, regarding the “steel sheet surface” based on the position of the sheet thickness direction of the steel sheet, that is, the depth position of the steel sheet, in this Description, in the later explained high frequency glow discharge spectrometry (below, sometimes referred to as “high frequency GDS analysis”), the depth position where the emission intensity of Fe reaches 0.7 time the inside emission intensity of Fe is defined as the 0 μm position and this 0 μm position is deemed the steel sheet surface. The “inside emission intensity of Fe” is the emission intensity of Fe at a region of a sufficient depth of the base steel sheet. This region is a region with almost no change in concentration of Fe in the depth direction and a region judged as “steel” as technical common sense. The inside emission intensity of Fe, for example, may be made the emission intensity of Fe at a sputter time of 1000 seconds.

It should be noted that, the “steel sheet” covered by the present invention is sometimes the “base steel sheet” having some sort of covering on its surface such as the plated steel sheet 1 shown in FIG. 1. In such a case, the “steel sheet surface” forming the basis for the depth position of the steel sheet becoming the steel sheet surface of the base steel sheet, but in the same way as the above, the emission intensity of Fe at the high frequency GDS analysis is the depth position reaching 0.7 time of the inside emission intensity of Fe, that is, the 0 μm position.

For example, in the plated steel sheet 1 shown in FIG. 1, the steel sheet surface is the position of the symbol “S_{d}” shown by the broken lines near the interface of the base steel sheet 2 and the plating layer 3. This position, as explained above, is the depth position where the emission intensity of Fe reaches 0.7 time the inside emission intensity of Fe in high frequency GDS analysis, that is, the 0 μm position.

Further, the expression of “depth position of 30 μm from the steel sheet surface” etc. also similarly means the position moved in the sheet thickness direction from the steel sheet surface by exactly the distance of 30 μm toward the center part of the steel sheet. For example, in the plated steel sheet 1 shown in FIG. 1, the depth position P₃₀ of 30 μm from the steel sheet surface S_{d} is the position moved in the sheet thickness direction from the steel sheet surface S_{d} by exactly the distance of 30 μm toward the center part of the steel sheet.

### <Plated Steel Sheet>

As shown in FIG. 1, the plated steel sheet 1 is plated steel sheet having the base steel sheet 2 of the present embodiment and a plating layer 3 provided on both surfaces of the base steel sheet 2. It should be noted that, the plating layer 3 may also be provided on one surface of the base steel sheet 2.

Further, the plated steel sheet 1, as shown in FIG. 1, has a surface layer part P_{S} defined as a region in the sheet thickness direction from the steel sheet surface S_{d} to a depth position P₁₅₀ of 150 μm.

### <Base Steel Sheet>

Further, in the present embodiment, the base steel sheet 2 has the following features:
First, the chemical composition of the base steel sheet 2 contains, by mass %,
C: 0.15 to 0.35%,
Si: 0.01 to 1.20%,
Mn: 1.00 to 3.50%,
Al: 0.300 to 1.500%,
Ti: 0.001 to 0.100%,
B: 0.0005 to 0.0050%,
P: 0.050% or less,
S: 0.0100% or less,
N: 0.010% or less,
O: 0.0100% or less,
Cr: 0 to 1.00%,
Mo: 0 to 1.00%,
Cu: 0 to 1.00%,
Ni: 0 to 1.00%,
Co: 0 to 1.00%,
W: 0 to 1.00%,
Sn: 0 to 1.00%,
Sb: 0 to 0.50%,
Nb: 0 to 0.200%,
V: 0 to 1.00%,
As: 0 to 0.10%,
Zn: 0 to 1.00%,
Ca: 0 to 0.0100%,
Mg: 0 to 0.0100%,
Zr: 0 to 0.0100%,
Hf: 0 to 0.0100%,
Bi 0 to 0.0100%,
REM: 0 to 0.015%, and
bal.: Fe and impurities.

A microstructure in a range of a ⅛ depth position to ⅜ depth position of sheet thickness of the base steel sheet 2 comprises, by area %, ferrite: 0 to 50%, retained austenite: 6 to 30%, total of fresh martensite and cementite: 0 to 10%, pearlite: 5% or less, tempered martensite: 5% or more, and bal.: bainite.

Further, the surface layer part P_{S} of the base steel sheet 2 has a deboronized layer P_{B} with an emission intensity of B, measured by high frequency glow discharge spectrometry in the depth direction from the steel sheet surface S_{d}, satisfying the following formula (1) and formula (2):

$$B 30 / B 150 < 0 \text{.90} \qquad ( 1 )$$

$$0.9 \leq B 140 / B 150 \leq 1 \text{.10} \qquad ( 2 )$$

where,
B30: emission intensity of B at depth position of 30 μm from steel sheet surface S_{d}
B140: emission intensity of B at depth position of 140 μm from steel sheet surface S_{d}
B150: emission intensity of B at depth position of 150 μm from steel sheet surface S_{d}

Further, the surface layer part P_{S} of the base steel sheet 2 has an emission intensity of C, measured by high frequency glow discharge spectrometry in the depth direction from the steel sheet surface S_{d}, satisfying the following formula (3) and formula (4):

$$C 30 / C 150 \leq 0 \text{.50} \qquad ( 3 )$$

$$0.9 \leq C 140 / C 150 \leq 1 \text{.10} \qquad ( 4 )$$

C30: emission intensity of C at depth position of 30 μm from the steel sheet surface
C140: emission intensity of C at depth position of 140 μm from the steel sheet surface
C150: emission intensity of C at depth position of 150 μm from the steel sheet surface

Further, the tensile strength of the base steel sheet 2 is 980 MPa or more.

Below, these features in the base steel sheet 2 will be explained in detail.

### (Chemical Composition)

First, the reasons for limiting the chemical composition of the base steel sheet according to the present invention (below, sometimes simply referred to as the “steel sheet”) in the above-mentioned way will be explained. It should be noted that, in this Description, the “%”s prescribing the chemical composition, unless particularly indicated otherwise, are all “mass %”. Further, in this Description, the “to” indicating a numerical range, unless particularly indicated otherwise, is used in the sense including the numbers described before and after it as the lower limit value and upper limit value.

### (C: 0.15 to 0.35%)

C (carbon) is an element essential for securing the desired steel sheet strength and EL by formation of retained austenite. The C content is 0.15% or more. The C content may also be 0.16% or more, 0.17% or more, or 0.18% or more. Further, from the viewpoint of securing the LME cracking resistance and bendability after imparting prestrain, the C content is 0.35% or less. The C content may also be 0.30% or less, 0.28% or less, or 0.25% or less.

### (Si: 0.01 to 1.20%)

Si (silicon) is an element suppressing the formation of iron carbides and contributing to securing the desired steel sheet strength and EL by formation of retained austenite. However, if the Si content is excessive, the LME cracking resistance is made to deteriorate. Accordingly, the Si content is 0.01 to 1.20%. The Si content may also be 0.05% or more, 0.10% or more, 0.15% or more, or 0.20% or more. Further, the Si content may also be 1.10% or less, 1.00% or less, or 0.90% or less.

### (Mn: 1.00 to 3.50%)

Mn (manganese) is a powerful austenite stabilizing element and an element effective for raising the strength of steel sheet. From the viewpoint of strength, weldability, and low temperature toughness, the content of Mn is 1.00 to 3.50%. The Mn content may be 1.10% or more, 1.30% or more, or 1.50% or more. Further, the Mn content may also be 3.30% or less, 3.10% or less, or 3.00% or less.

### (Al: 0.300 to 1.500%)

Al (aluminum) is an element contained for deoxidizing steel. Further, Al is an element suppressing the formation of iron carbides and contributing to improvement of the EL by formation of retained austenite. From the viewpoint of sufficiently obtaining these effects, the Al content is 0.300% or more. The Al content may also be 0.400% or more or 0.500% or more. On the other hand, if Al is excessively contained, it triggers embrittlement of the steel and causes deterioration of the bendability after imparting prestrain, and therefore the upper limit of the Al content is 1.500%. The Al content is preferably 1.200% or less, 1.000% or less, or 0.800% or less.

### (Ti: 0.001 to 0.100%)

Ti (titanium) is an element effective for raising the strength of steel sheet. From the viewpoints of raising the strength and cost, the Ti content is 0.001 to 0.100%. The Ti content may also be 0.005% or more, 0.010% or more, 0.015% or more, or 0.020% or more. Further, the Ti content may also be 0.080% or less, 0.070% or less, or 0.050% or less.

### (B: 0.0005 to 0.0050%)

B (boron) is an element raising the quenchability of steel sheet and raising the strength. It is an essential element in the present invention. Further, B segregates at the austenite grain boundaries at the time of spot welding and strengthens the austenite grain boundaries to thereby improve the LME cracking resistance. In the present invention, by forming the later explained deboronized layer at the surface layer part of the steel sheet, it is possible to improve the bendability after plastic working. From the viewpoint of forming a suitable deboronized layer, the B content is 0.0005 to 0.0050%. The B content may also be 0.0007% or more, 0.0010% or more, or 0.0015% or more. Further, the B content may also be 0.0040% or less, 0.0035% or less, or 0.0030% or less.

### (P: 0.050% or Less)

P (phosphorus) is an element contained in steel as an impurity. It contributes to higher strength of the steel sheet as well by solution strengthening, but from the viewpoints of weldability and toughness, the P content is 0.050% or less. The P content is preferably 0.045% or less, 0.035% or less, or 0.020% or less. P is not an essential element. The lower limit of the P content is 0%. However, to greatly reduce the P content, the dephosphorization cost becomes higher, and therefore from the viewpoint of economy, the lower limit of the P content may be 0.0001%, 0.0005%, or 0.001%.

### (S: 0.0100% or Less)

S (sulfur) is an element contained in steel as an impurity and an element forming MnS in steel sheet to cause deterioration of the toughness and hole expandability. Therefore, from the viewpoint of suppressing the deterioration of the toughness and hole expandability, the S content is 0.0100% or less. The S content is preferably 0.0050% or less, 0.0040% or less, or 0.0030% or less. S is not an essential element. The lower limit of the S content is 0%. However, to greatly reduce the S content, the desulfurization cost becomes higher, so from the viewpoint of economy, the lower limit of the S content may be 0.00001%, 0.00005%, or 0.0001%.

### (N: 0.010% or Less)

N (nitrogen) is an element contained in steel as an impurity and an element which, when its content is more than 0.0100%, forms rough nitrides in the steel and causes the bendability and hole expandability to deteriorate. Therefore, the N content is 0.0100% or less. The N content is preferably 0.008% or less, 0.006% or less, or 0.005% or less. N is not an essential element, and therefore the lower limit of the N content is 0%. However, to greatly reduce the N content, the denitridation cost becomes high, and therefore from the viewpoint of economy, the lower limit of the N content may also be 0.00010%, 0.0005%, or 0.0010%.

### (O: 0.0100% or Less)

O (oxygen) is an element contained in steel as an impurity and an element, which if its content is more than 0.0100%, forms coarse oxides in the steel to cause deterioration of the bendability and hole expandability. Therefore, the O content is 0.0100% or less. The O content is preferably 0.0080% or less, 0.0060% or less, or 0.0050% or less. O is not an essential element, and therefore the lower limit of the O content is 0%. However, from the viewpoint of the production cost, the lower limit of the O content may also be 0.00001%, 0.00005%, or 0.0001%.

The basic chemical composition of the base steel sheet 2 in the present embodiment is as explained above. Further, the base steel sheet 2 may also contain any of the following optional elements in accordance with need.

### (Cr: 0 to 1.00%, Mo: 0 to 1.00%, Cu: 0 to 1.00%, Ni: 0 to 1.00%, Co: 0 to 1.00%, W: 0 to 1.00%, Sn: 0 to 1.00%, Sb: 0 to 0.50%, Nb: 0 to 0.200%, V: 0 to 1.00%, As: 0 to 0.10%, and Zn: 0 to 1.00%)

Cr (chromium), Mo (molybdenum), Cu (copper), Ni (nickel), Co (cobalt), W (tungsten), Sn (tin), Sb (antimony), Nb (niobium), V (vanadium), As (arsenic), and Zn (zinc) are all elements effective for raising the strength of steel sheet. For this reason, one or more of these elements may be added in accordance with need. From the viewpoint of the effect and cost due to inclusion of these elements, the contents of these elements are Cr: 0 to 1.00%, Mo: 0 to 1.00%, Cu: 0 to 1.00%, Ni: 0 to 1.00%, Co: 0 to 1.00%, W: 0 to 1.00%, Sn: 0 to 1.00%, Sb: 0 to 0.50%, Nb: 0 to 0.200%, V: 0 to 1.00%, As: 0 to 0.10%, and Zn: 0 to 1.00%. The contents of these elements may also be 0.005% or more or 0.010% or more.

### (Ca: 0 to 0.0100%, Mg: 0 to 0.0100%, Zr: 0 to 0.0100%, Hf: 0 to 0.0100%, Bi: 0 to 0.0100%, REM: 0 to 0.015%)

Ca (calcium), Mg (magnesium), Zr (zirconium), Hf (hafnium), and an REM (rare earth metals) are all elements contributing to fine dispersion of inclusions in the steel. Bi (bismuth) is an element mitigating microsegregation of Mn, Si, and other substitution type alloy elements in the steel. These elements contribute to improvement of the workability of steel sheet, so, in accordance with need, one or more of these elements may be added. From the viewpoint of the workability and ductility, the upper limits of the contents of Ca, Mg, Zr, Hf, and Bi are respectively 0.0100%. Further, from a similar viewpoint, the upper limit of the REM content is 0.015%. It should be noted that the REM content may also be 0.010% or less. The contents of Ca, Mg, Zr, Hf, Bi, and REM may also respectively be 0.0005% or more or 0.0010% or more.

In the present embodiment, the balance besides the above elements of the base steel sheet 2 is comprised of Fe and impurities. In this case, the “impurities” contained in the balance besides the above constituents are constituents entering due to the ore, scrap, or other raw materials and other various factors in the production process when industrially producing the steel sheet. The impurities include constituents not intentionally added to the base steel sheet 2. Further, the impurities contained in the balance are elements other than the constituents explained above and also include elements contained in steel sheet within an extent where the actions and effects distinctive to the elements in the impurities do not affect the properties of the base steel sheet 2.

It should be noted that, if the steel sheet is surface treated steel sheet, the chemical composition is the contents of the base steel sheet from which the covering at the surface has been peeled off. Further, in the case where the steel sheet is steel sheet not accompanied by a plating layer or a surface treated layer or other covering, the chemical composition is the content of the steel sheet itself.

The chemical composition of the steel sheet may be measured by a general analysis method. For example, the chemical composition of the steel sheet may be measured by using inductively coupled plasma-atomic emission spectrometry (ICP-AES). Specifically, for example, the front and back of the steel sheet are ground down to depth positions of 200 μm from the steel sheet surfaces to obtain a test piece. An ICPS-8100 or other measuring device made by Shimadzu Corporation can be used under conditions based on calibration curves prepared in advance to thereby identify the chemical composition of the steel sheet. C and S, which cannot be measured by ICP-AES, can be measured using the combustion-infrared absorption method, N can be measured using the inert gas melting-thermal conductivity method, and O can be measured using the inert gas melting-nondispersive type infrared absorption method.

### [Microstructure Inside of Steel Sheet]

Next, the reasons for limitation of the internal structure of the base steel sheet 2 according to the present embodiment will be explained. It should be noted that, in this Description, the “%” prescribing the microstructure all mean “area %” unless particularly indicated otherwise.

### (Ferrite: 0 to 50%)

Ferrite is excellent in ductility, but is a soft structure. To improve the elongation of steel sheet, it may be included in accordance with the required strength and ductility. From the viewpoint of securing strength, the upper limit of the ferrite content is 50%. The ferrite content may be 45% or less, 40% or less, 35% or less, or 30% or less. The ferrite content may also be 0% and may also be 3% or more, 5% or more, or 10% or more.

### (Retained Austenite: 6 to 30%)

Retained austenite is a structure contributing to improvement of the ductility of steel sheet by the effect of work induced transformation. Accordingly, the lower limit of the retained austenite content is 6%. The retained austenite content is preferably 7% or more, 8% or more, 9% or more, or 10% or more. On the other hand, retained austenite transforms induced by work to thereby transform to martensite as quenched, and therefore sometimes causes deterioration of the bendability of steel sheet. Further, retained austenite is a brittle structure, and therefore forms starting points of fracture at the time of plastic deformation and sometimes cause deterioration of the local ductility of steel sheet. Therefore, the upper limit of the retained austenite content is a total of 30%. The retained austenite content is preferably 25% or less, 20% or less, or 18% or less.

### (Total of Fresh Martensite and Cementite: 0 to 10%)

Fresh martensite and cementite are brittle structures, and therefore become starting points for fracture at the time of plastic deformation and sometimes cause deterioration of the local ductility of steel sheet. For similar reasons, fresh martensite and cementite sometimes cause deterioration of the bendability after imparting prestrain. Therefore, the upper limit of the total content of fresh martensite and cementite is 10%. The total content of fresh martensite and cementite is preferably 8% or less, 7% or less, or 6% or less. In this case, “cementite” covers coarse particles of a circle equivalent diameter of more than 1 μm. “Fine cementite” precipitating in bainite or martensite is not included. Further, the lower limit of the total of fresh martensite and cementite is 0%. The total content of fresh martensite and cementite may also be 1% or more or 2% or more.

### (Pearlite: 5% or Less)

Pearlite contains hard and coarse cementite and becomes starting points of fracture at the time of plastic deformation, and therefore, in particular, if the pearlite content is more than 5%, sometimes the local ductility of the steel sheet is made to deteriorate. For similar reasons, pearlite sometimes causes deterioration of the bendability after imparting prestrain. Therefore, the pearlite content is 5% or less. The pearlite content may be 3% or less or 2% or less. Further, the lower limit of the pearlite content is 0%. The pearlite content may also be 1% or more or 2% or more.

### (Tempered Martensite: 5% or More)

Tempered martensite is a high strength and tough structure and is also a structure raising the tensile strength and bending load of steel sheet. To obtain the desired tensile strength and bendability, the lower limit of the tempered martensite content is 5% or more. The tempered martensite content is preferably 10% or more, 15% or more, 20% or more, 25% or more, or 30% or more. The upper limit of the tempered martensite content is not particularly prescribed, but is for example 94%. The tempered martensite content may also be 92% or less, 90% or less, or 88% or less.

### (Balance: Bainite)

The balance structure other than the above structures may also be 0%, but if there is such a balance structure present, that balance structure is bainite. Furthermore, the bainite of the balance structure may be either of upper bainite and lower bainite and may be mixed structures of the same.

The microstructure fractions of the steel sheet are, as follows, evaluated by the secondary electron image captured using a field emission type scan electron microscope (FE-SEM) and by the X-ray diffraction method.

First, a sample is taken from the steel sheet using a cross-section of sheet thickness parallel to the rolling direction and at the center position in the width direction of the steel sheet as an examined surface. The examined surface of the sample is machine ground to finish it to a mirror surface, then the surface is etched by a Nital solution.

Next, in one or more examined fields in the range at the ⅛ depth position to ⅜ depth position of sheet thickness of the steel sheet at the examined surface centered about the ¼ depth position of the sheet thickness, a secondary electron image of a region of a total of 2.0×10⁻⁹ m² or more in area is captured.

From the obtained secondary electron image, the area ratios of the ferrite, retained austenite, bainite, tempered martensite, fresh martensite, cementite, and pearlite are measured. Regions having substructures in the grains and having several variants of cementite are judged to be tempered martensite. Regions having cementite precipitated in a lamellar form are judged to be pearlite (or total of pearlite and cementite). In the fields including various substructures, regions with relatively small brightness and no substructures observed are judged to be ferrite. Regions with relatively large brightnesses and with substructures not appearing by etching are judged to be fresh martensite, retained austenite, and cementite. Regions not corresponding to any of the above regions are judged to be bainite.

The area ratios of the different structures are calculated by the point counting method to obtain the area ratios of the structures. The total area ratio of the fresh martensite and cementite can be found by subtracting the area ratio of retained austenite found by the later explained X-ray diffraction method.

The existence ratio of retained austenite is measured by the X-ray diffraction method.

First, a portion down to the ¼ depth position of the sheet thickness in the sheet thickness direction from the sheet thickness surface of the steel sheet is removed by mechanical polishing and chemical polishing. Further, after polishing, the sample is analyzed using MoKα1 rays as the characteristic X-rays. The structural fraction of the retained austenite is calculated from the integrated intensity ratio of the diffraction peaks of (200) and (211) of the bcc phase and (200), (220), and (311) of the fcc phase. This is made the existence ratio of the retained austenite. The obtained existence ratio is deemed the area ratio.

If the area ratio of the total of the structures obtained by the above method of evaluation is less than 100%, the balance regions are judged as bainite. Further, if the area ratio of the total of the structures obtained by the above method of evaluation is more than 100%, the value obtained by multiplying the area ratio of the structures by 100/(area ratio of total of structures) is made the area ratio of the structures.

### [Deboronized Layer]

In the present embodiment, the base steel sheet 2, as explained above, has a deboronized layer P_{B} at the surface layer part P_{S}. In this Description, a portion where the emission intensity of B, measured by high frequency glow discharge spectrometry (high frequency GDS analysis) in the depth direction from the steel sheet surface, satisfies the following formula (1) and formula (2) is defined as the “deboronized layer”.

$$B 30 / B 150 < 0 \text{.90} \qquad ( 1 )$$

$$0.9 \leq B 140 / B 150 \leq 1 \text{.10} \qquad ( 2 )$$

In this case, B30, B140, and B150 are respectively, when measured by high frequency GDS analysis from the steel sheet surface in the sheet thickness direction, the emission intensity of B at a depth position of 30 μm from the steel sheet surface, the emission intensity of B at a depth position of 140 μm from the steel sheet surface, and the emission intensity of B at a depth position of 150 μm from the steel sheet surface.

The measurement by high frequency GDS analysis is performed at any five positions. B30, B140, and B150 are respectively the average values of emission intensity of B at depth positions of 30 μm, 140 μm, and 150 μm from the steel sheet surface at the any five positions. The measurement conditions are as follows:

B30, B140, and B150 are respectively measured using ahigh frequency glow discharge spectrometer. Specifically, the method is used of making the surface of the steel sheet to be measured an Ar atmosphere, applying voltage to generate glow plasma, and in that state causing sputtering at the surface of the steel sheet while analyzing the sheet in the depth direction. Further, the emission spectral wavelengths distinctive to the elements emitted due to excitation of atoms in the glow plasma are used to identify the elements contained in the steel sheet and estimate the emission intensities of the identified elements.

The depth direction data can be estimated from the sputter time. Specifically, by using standard samples in advance to find the relationship of the sputter time and sputter depth, it is possible to convert the sputter time to the sputter depth. Therefore, the sputter depth converted from the sputter time can be defined as the depth from the steel sheet surface. The sputter time is set so that at least the sputter depth exceeds 150 μm.

In the high frequency GDS analysis, a commercially available analysis apparatus can be used. In the present embodiment, a high frequency glow discharge spectrometer GD-Profiler2 (TM) made by Horiba is used. The detection pitch is 0.1 second. The obtained data is stripped of the background, then filtered. The filtering is performed by the moving average method. Specifically, the moving average of a total of 51 points of the center point+front/back 25 points is found. The values of the times corresponding to the 30 μm depth, 140 μm depth, and 150 μm depth are respectively B30, B140, and B150. The other measurement conditions are as follows:
Ar gas pressure: 600 Pa
Anode diameter: 4 mmφ
RF output: 35 W

It should be noted that, in this Description, as explained above, the depth position where the emission intensity of Fe according to high frequency GDS analysis reaches 0.7 time the inside emission intensity of Fe is defined as the 0 μm position, but the inside emission intensity of Fe in this definition may, for example, be made the emission intensity of Fe at the sputter time of 1000 seconds.

The above formula (1) means the boron concentration at the depth position of 30 μm from the steel sheet surface is less than 0.90 time the boron concentration at the depth position of 150 μm. By satisfying this formula (1), when the steel sheet is plastically worked, the metallostructure near the steel sheet surface becomes harder to be damaged.

In the above (1), B30/B150 may be 0.80 or less, less than 0.80, 0.70 or less, less than 0.70, 0.60 or less, less than 0.60, 0.50 or less, or less than 0.50. Further, B30/B150 may also be 0, but may also be 0.10 or more, 0.20 or more, or 0.30 or more.

Formula (2) means the emission intensity of B at the depth position of 140 μm from the steel sheet surface and the Be emission intensity at the depth position of 150 μm from the steel sheet surface are roughly equal. In other words, the region where the deboronized layer P_{B} can be formed in the present embodiment means down to the depth position of 150 μm from the steel sheet surface. By satisfying this formula (2), it is possible to prevent the depth position of 150 μm or more from the steel sheet surface from excessively ending up softening and secure the steel sheet strength.

By forming the above such deboronized layer P_{B}, it is possible to improve the bendability after plastic working. The reason why such an effect is obtained is not clear, but there may be a possibility of the damage to the metallostructure (for example, formation of microvoids etc.) when receiving plastic working being slighter in the soft layer of the surface layer formed by the deboronized layer P_{B} compared with the soft layer of the surface layer formed by the decarburized layer.

It should be noted that, as explained above, B (boron) segregates at the austenite grain boundaries at the time of spot welding and strengthens the austenite grain boundaries to thereby improve the LME cracking resistance. Due to this mechanism, the formation of the deboronized layer P_{B} causes the B at the austenite grain boundaries to decrease, and therefore it would appear at first glance that the LME cracking resistance would be made to deteriorate. However, in actuality, it was confirmed that even if forming a deboronized layer P_{B}, the LME cracking resistance did not deteriorate. This is believed to be because the heat input at the time of spot welding causes the temperature to rise near the welded spot whereby the B inside the steel sheet diffuses to the surface layer part P_{S} of the steel sheet and therefore the amount of segregated B at the austenite grain boundaries at the surface layer part P_{S} of the steel sheet becomes sufficiently large even if the deboronized layer P_{B} had been formed. Therefore, it is believed that even if the deboronized layer P_{B} had been formed at the surface layer part P_{S} of the steel sheet before welding, the effect of improvement of the LME cracking resistance by B was obtained.

Further, the base steel sheet 2 of the present embodiment may have a decarburized layer at the surface layer part P_{S}, that is, the base steel sheet 2 may be decarburized (below, sometimes simply referred to as “decarburization”), so as to improve more the LME cracking resistance. Specifically, at the surface layer part P_{S} of the base steel sheet 2, the emission intensity of C, measured by high frequency glow discharge spectrometry (high frequency GDS analysis) in the depth direction from the steel sheet surface, satisfies the following formula (3) and formula (4).

$$C 30 / C 150 \leq 0 \text{.50} \qquad ( 3 )$$

$$0.9 \leq C 140 / C 150 \leq 1 \text{.10} \qquad ( 4 )$$

In this case, C30, C140, and C150 are respectively, when measured from the steel sheet surface in the sheet thickness direction by high frequency GDS analysis, the emission intensity of C at the depth position of 30 μm from the steel sheet surface, the emission intensity of C at the depth position of 140 μm from the steel sheet surface, and the emission intensity of C at the depth position of 150 μm from the steel sheet surface.

The measurement by high frequency GDS analysis is performed at any five positions. C30, C140, and C150 are respectively the average values of emission intensity of C at depth positions of 30 μm, 140 μm, and 150 μm from the steel sheet surface at the any five positions. The measurement conditions are similar to the above-mentioned B30, B140, and B150.

The above formula (3) means that the decarburization proceeds at least to the depth position of 30 μm from the steel sheet surface. By decarburization so as to satisfy the formula (3), the LME cracking resistance can be improved more.

In the above formula (3), C30/C150 may be 0.45 or less, 0.40 or less, or 0.35 or less. Further, C30/C150 may also be 0, but may also be 0.10 or more, 0.15 or more, or 0.20 or more.

The degree of the decarburization can be controlled by adjusting the atmosphere up to heating to the maximum heating temperature at the heat treatment of the method of production of the steel sheet explained later.

The formula (4) means that the emission intensity of C at the depth position of 140 μm from the steel sheet surface and the emission intensity of C at the depth position of 150 μm from the steel sheet surface are roughly equal. That is, it means the decarburized depth is 140 μm or less. It should be noted that the C concentration at the depth position of 150 μm from the steel sheet surface becomes roughly equal to the C concentration at the center of sheet thickness of the steel sheet surface. If formula (4) is not satisfied, that is, if decarburization excessively proceeds, the tensile strength excessively falls and sometimes the desired tensile strength cannot be obtained.

### [Tensile Strength: 980 MPa or More]

In the present embodiment, the tensile strength of the base steel sheet 2 is 980 MPa or more. The base steel sheet 2 of the present embodiment, even if the tensile strength is such a high strength, has the above-mentioned decarburized deboronized layer P_{B}, and therefore is excellent in LME cracking resistance and bendability after plastic working. The tensile strength of the base steel sheet 2 may also be 1180 MPa or more, 1200 MPa or more, 1300 MPa or more, 1400 MPa or more, or 1500 MPa or more. It should be noted that the upper limit of the tensile strength of the base steel sheet 2 is not particularly limited, but from the viewpoint of the toughness and shapeability, for example, it may be 4000 MPa or less, 3000 MPa or less, or 2000 MPa or less.

It should be noted that the tensile strength (TS) of the steel sheet can be measured in the following way. First, a No. 5 test piece of JIS Z 2241: 2011 having a direction perpendicular to the rolling direction as a longitudinal direction is taken from the center part of width of the steel sheet to be measured. Next, this test piece can be used for performing a tensile test based on JIS Z 2241: 2011 to measure the tensile strength TS (MPa).

Further, if obtaining a test piece from the steel sheet to be measured is difficult, it is possible to measure the Vickers hardness of the steel sheet and use the measured value of the Vickers hardness to derive the tensile strength from the following correlation formula (Correlation Between Static Strength Parameters, Fumihiko Hasegawa, Junichi Arai, Tsuneshichi Tanaka, “Materials”, Vol. 39, No. 442, P. 859 to 863).

Hv=0.301×TS+5.701
where, in the above formula, “Hv” indicates the Vickers hardness and “TS” indicates the tensile strength (MPa).

The Vickers hardness of the steel sheet can be measured in accordance with JIS Z 2244: 2009. Specifically, the Vickers hardness of the steel sheet can be obtained by performing measurement by a load of 1 kgf (about 9.80N) 10 times at a ¼ depth position of the sheet thickness of the steel sheet and finding the average value of the 10 measured values. At this time, the interval between the measurement positions is made a distance of 3× or more of the indentations.

### [Plating Layer]

As explained above, in the present embodiment, both sides of the base steel sheet 2 have the plating layer 3. The plating layer 3 may also be a hot dip galvanized layer or hot dip galvannealed layer having any known composition. The plating layer 3 may also include Al and other added elements besides Zn. Further, the amount of deposition of the plating layer 3 is not particularly limited and may be a general amount of deposition.

It should be noted that the plating layer 3 may be provided at only one surface of the base steel sheet 2 and may be provided at any surface of the base steel sheet 2. In the steel sheet of the present invention, it is not essential that the surface of the steel sheet have a plating layer.

### (Thickness of Steel Sheet)

The thickness of the steel sheet of the present invention is not particularly limited. For example, it may be made a thickness similar to the steel sheet used for automobile parts. As such a thickness of the steel sheet, for example, a 0.5 to 3.0 mm thickness may be mentioned. The thickness of the steel sheet may also be 0.7 mm or more, 0.8 mm or more, or 1.0 mm or more. Further, the thickness of the steel sheet may also be 2.8 mm or less, 2.5 mm or less, or 2.0 mm or less.

### <Method of Production of Steel Sheet>

Next, the method of production of steel sheet according to one embodiment of the present invention will be explained. The following explanation is intended to illustrate the characteristic method for production of the steel sheet according to an embodiment of the present invention and is not intended to limit the steel sheet to one produced by the method of production explained below.

The method of production of the steel sheet includes a hot rolling step (a) of hot rolling a slab having a specific chemical composition to obtain a hot rolled steel sheet (below, sometimes simply referred to as “step (a)”), a grinding step (e) of grinding the hot rolled steel sheet by a rotary grinding brush (below, sometimes simply referred to as “step (c)”), a pickling step (b) of pickling after grinding (below, sometimes simply referred to as “step (b)”), a cold rolling step (c) of cold rolling the pickled hot rolled steel sheet to obtain cold rolled steel sheet (below, sometimes simply referred to as “step (c)”), and a heat treatment step (d) of heat treating the cold rolled steel sheet (below, sometimes simply referred to as “step (d)”.

Below, preferable conditions etc. of these steps will be explained in detail.

[Hot Rolling Step (a)]

First, a slab having the following specific chemical composition is hot rolled under predetermined conditions to obtain a hot rolled steel sheet, then the hot rolled steel sheet is cooled down to a predetermined temperature and coiled in a hot rolling step (a). In the hot rolling step, a slab having the following specific chemical composition is heated before hot rolling.

In this case, regarding the chemical composition of the slab, if analyzing the chemical composition of the finally obtained steel sheet by the above-mentioned method of analysis, it can be confirmed that there is substantially no difference from the chemical composition of the slab.

Therefore, the chemical composition of the slab basically is the same as the above-mentioned chemical composition of the steel sheet. That is, the chemical composition of the slab comprises, by mass %,
C: 0.15 to 0.35%,
Si: 0.01 to 1.20%,
Mn: 1.00 to 3.50%,
Al: 0.300 to 1.500%,
Ti: 0.001 to 0.100%,
B: 0.0005 to 0.0050%,
P: 0.050% or less,
S: 0.0100% or less,
N: 0.010% or less,
O: 0.0100% or less,
Cr: 0 to 1.00%,
Mo: 0 to 1.00%,
Cu: 0 to 1.00%,
Ni: 0 to 1.00%,
Co: 0 to 1.00%,
W: 0 to 1.00%,
Sn: 0 to 1.00%,
Sb: 0 to 0.50%,
Nb: 0 to 0.200%,
V: 0 to 1.00%,
As: 0 to 0.10%,
Zn: 0 to 1.00%,
Ca: 0 to 0.0100%,
Mg: 0 to 0.0100%,
Zr: 0 to 0.0100%,
Hf: 0 to 0.0100%,
Bi 0 to 0.0100%,
REM: 0 to 0.015%, and
bal.: Fe and impurities.

It should be noted that, the preferable contents of the constituents in the chemical composition of the slab etc. are basically the same as the chemical composition of the above-mentioned steel sheet.

In the hot rolling step, the heating temperature of the slab is not particularly limited, but to sufficiently dissolve the borides, carbides, etc., in general it is preferably 1150° C. or more. It should be noted that, the steel slab used is preferably cast by the continuous casting method from the viewpoint of productivity, but it may also be produced by the ingot making method or thin slab casting method.

### (Rough Rolling)

In the method of production, the heated slab may be rough rolled before the finish rolling so as to adjust the sheet thickness etc. The conditions of such rough rolling are not particularly limited, but from the viewpoint of recrystallization during hot rolling, rough rolling is preferably performed so that the total rolling reduction at 1050° C. or more becomes 60% or more. The total rolling reduction may, for example, be 90% or less.

### (Finish Rolling)

Next, the above-mentioned slab is hot rolled by finish rolling to obtain the hot rolled steel sheet. The finish rolling entry side temperature at the finish rolling is not particularly limited, but to make the structure of the hot rolled steel sheet a suitable one, it is preferably 900 to 1050° C. Further, the total rolling reduction at the finish rolling is preferably 70 to 95%.

In the present method of production, to form the above-mentioned deboronized layer, finish rolling is performed by three or more passes, the rolling reduction of the respective passes of the final three passes at the finish rolling is 20% or more, the time between passes is within 1 second, the entry side steel sheet temperature before the final three passes is 1000° C. or less, and the finish rolling completion temperature is 850 to 950° C. Further, the time from after the completion of the final pass to the start of cooling is within 3 seconds. If performing the finish rolling under such conditions, the accumulation of strain at the austenite promotes ferrite transformation and causes the surface of the hot rolled steel sheet to soften whereby it is possible to promote the introduction of strain at the surface by the grinding of the next step and, as a result, it is possible to form the above-mentioned deboronized layer at the final product steel sheet. The number of passes of the finish rolling is not particularly limited so long as the final three passes satisfy the above-mentioned conditions.

It should be noted that, in this Description, the “final three passes” means the three passes of the pass of the third pass counted from the final pass, the pass of the second pass, and the pass of the first pass from among the three or more passes in the finish rolling.

### (Coiling Temperature: 450 to 680° C.)

The hot rolled steel sheet after the above-mentioned finish rolling is coiled after cooling down to a predetermined coiling temperature. At this time, the coiling temperature is 450 to 680° C. from the viewpoint of the strength and workability of the hot rolled sheet. The coiling temperature may also be 500° C. or more. Further, the coiling temperature may be 620° C. or less.

After finishing the coiling, for the purpose of promoting the formation of a deboronized layer at the later explained heat treatment step, it is also possible to add a step of retaining the heat of the coiled hot rolled steel sheet in a heat insulating vessel. As one example of the heat retention step, the hot rolled steel sheet may be placed in a heat insulating vessel with inside walls covered by a heat insulation material so as to retain the heat within 30 minutes after the completion of coiling. At this time, the heat retention conditions may be a peak temperature of the atmosphere inside the vessel of 500 to 650° C. and a time until the temperature of the atmosphere reaches the above peak temperature of 1 to 8 hours. If retaining the heat under such conditions, the surface layer part of the hot rolled steel sheet further softens, introduction of strain in the following grinding step is promoted, and formation of a deboronized layer at the later explained heat treatment step is further promoted, whereby the bendability after plastic working the finally obtained steel sheet can be further improved.

[Grinding Step (e)]

Next, the front and back surfaces of the coiled steel sheet are ground using a rotary grinding brush in the grinding step (e). As the brush able to be used in the grinding step, for example, D-100-33 made by Hotani etc. may be mentioned. The grinding conditions are a rotational speed R (rpm) of the grinding brush, diameter D (m) of the grinding brush, and the running speed V (m/min) of the steel sheet are set to satisfy the following formula (5). If grinding under conditions satisfying such a formula (5), by strain being introduced in the surface layer part of the steel sheet, diffusion of boron is promoted at the later explained heat treatment step and the deboronized layer formed at the later explained heat treatment step is expanded.

$$[ Mathematical 2 ]$$

$$\frac{R \cdot D}{V} > 10 \qquad ( 5 )$$

It should be noted that, in formula (5), (R·D)/V may be 11 or more, 13 or more, or 15 or more. Further, the upper limit of the (R·D)/V is not particularly prescribed, but (R·D)/V may be 60 or less, 55 or less, or 50 or less.

Such a step (e) has to be performed at a time from the completion of the hot rolling to before the cold rolling. It may be performed at a timing of either before the later explained pickling step or after the pickling step.

[Pickling Step (b)]

Next, the steel sheet after the hot rolling step (a) or the grinding step (e) is pickled in the pickling step (b). The method of pickling in the pickling step may be based on an ordinary method. Further, in the pickling step, skin pass rolling may be performed for correction of the shape of the hot rolled coil and improvement of pickling ability.

[Cold Rolling Step (c)]

Next, the steel sheet after the pickling step (b) or the grinding step (e) is cold rolled in the cold rolling step (c). In the cold rolling step, the rolling reduction of the cold rolling is 30 to 75% considering the accumulation of strain and the burden on the cold rolling mill due to the rolling load. For example, the rolling reduction may be 40% or more. Further, the rolling reduction may be 70% or less or 60% or less.

[Heat Treatment Step (d)]

Next, the steel sheet obtained at the cold rolling step (c) is heat treated in a heat treatment step (d). The heat treatment step is comprised of a successively performed step (d-1) of heating the steel sheet obtained at step (c) from 650° C. to the Ac1+50° C. or more and 950° C. or less maximum heating temperature by an average heating speed of 0.5 to 500° C./s, a step (d-2) of holding the steel sheet at the maximum heating temperature for 1 to 300 seconds, a step (d-3) of cooling the steel sheet down to an Ms point (martensite transformation point)−30° C. or less temperature in which the cooling from 700° C. to 500° C. is performed by cooling by a 10° C./s or more average cooling speed, and a step (d-4) of holding the steel sheet at 300 to 450° C. for 100 to 600 seconds.

The deboronation can be made to sufficiently proceed by controlling the hot rolling conditions as explained above to soften the surface layer part of the steel sheet, introducing a large amount of strain at the surface layer part of the steel sheet at the grinding step, and further making the H₂O in the atmosphere and the B of the surface of the steel sheet react to form oxides in the above step (d-1) to step (d-4) of the heat treatment step, that is, the temperature raising and soaking step.

At the above-mentioned step (d-1), the average heating speed up to the maximum heating temperature is 0.5 to 500° C./s from the viewpoint of causing recrystallization of ferrite to proceed and suppressing coarsening of austenite. The average heating speed may also be 1.0° C./s or more or 2.0° C./s or more. Further, the average heating speed may also be 400° C./s or less or 300° C./s or less. In this case, the “average heating speed” means the value obtained by dividing the difference between 650° C. and the maximum heating temperature by the time required for reaching the maximum heating temperature from 650° C.

At the above-mentioned step (d-1), the maximum heating temperature is Ac1+50° C. or more and 950° C. or less from the viewpoint of progression of austenization and suppression of coarsening of the austenite size. Further, at the above-mentioned step (d-2), the holding time at the maximum heating temperature is 1 to 300 seconds from the viewpoint of progression of the austenization and the productivity. While holding at the maximum heating temperature, the steel sheet does not necessarily have to be held at a constant temperature. The temperature may fluctuate within the range of the above maximum heating temperature. In this case, “holding” means maintaining the temperature within a range not exceeding the predetermined upper and lower limits at a predetermined temperature±20° C., preferably within a range of ±10° C.

After holding at the maximum heating temperature, at the above-mentioned step (d-3), the steel sheet is cooled down to the Ms point−30° C. or less temperature, but at this time, from 700° C. to 500° C., the steel sheet is cooled by a 10° C./s or more average cooling speed. The average cooling speed from 700° C. to 500° C. may be 20° C./s or more, 30° C./s or more, or 50° C./s or more.

To obtain the desired structure, after cooling down to the Ms point−30° C. or less temperature, at the above-mentioned step (d-4), the steel sheet is held at 300 to 450° C. for 100 to 600 seconds. The “holding” at this step (d-4), in the same way as above, does not require holding at a certain temperature. It means holding at the predetermined temperature±20° C., preferably within ±10° C. in range.

At the above-mentioned step (d-4), the atmosphere in the surroundings of the steel sheet when heating from 650° C. to the maximum heating temperature is controlled so that the steam partial pressure pH₂O and the hydrogen partial pressure pH₂ satisfy the following formula (6). If the log(pH₂O/pH₂) in formula (6) is less than −1.0, the decarburization reaction does not sufficiently proceed and the desired LME cracking resistance is not obtained. Further, if the log(pH₂O/pH₂) in formula (6) is more than −0.1, the effect of improvement of bendability becomes saturated and the strength of the steel sheet is liable to fall.

$$- 1. \leq log ( {pH}_{2} O / {pH}_{2} ) \leq - 0.1 \qquad ( 6 )$$

pH₂O: steam partial pressure
pH₂: hydrogen partial pressure

It should be noted that, the log(pH₂O/pH₂) in formula (6) may be −0.9 or more or −0.8 or more. Further, the log(pH₂O/pH₂) in formula (6) may be −0.2 or less or −0.3 or less.

As explained above, the steel sheet of the present invention may be formed with a plating layer at its surface. The plating layer can, for example, be a hot dip galvanized layer. Further, in accordance with need, after formation of the hot dip galvanized layer, the layer may be alloyed to form a hot dip galvannealed layer. The plating layer may be formed and the alloying may be performed in accordance with ordinary methods and are not particularly limited. The plating can be performed in the middle of cooling from the maximum heating temperature to a temperature of the Ms point−30° C. or less. In this case, the cooling may be ended once at the plating temperature and then after the plating ends, the cooling performed down to a temperature of the Ms point−30° C. or less by a 10° C./s or more average cooling speed. Further, the plating may be performed by the above-mentioned holding operation at 300 to 450° C. or may be performed by reheating the steel sheet to the plating bath temperature after the heat treatment step is finished and the sheet has been cooled to room temperature.

By the above method of production, it is possible to obtain the steel sheet of the present invention excellent in tensile strength and excellent in elongation (EL), LME cracking resistance, and bendability after plastic working. The bendability is evaluated by imparting 2% prestrain to a test piece taken from the steel sheet to be evaluated, then performing a bending test by the method prescribed in the Verband der Automobilindustrie (VDA) standard 238-100 and measuring the maximum bending angle.

### EXAMPLES

Next, an embodiment of the present invention will be explained. The conditions in this embodiment are one example of the conditions employed for confirming the feasibility and effects of the present invention. The present invention is not limited to this example of the conditions. The present invention can employ various conditions so long as not departing from the gist of the present invention and achieving the object of the present invention.

Steels having various chemical compositions were cast to prepare slabs. These slabs were used for hot rolling to produce hot rolled steel sheets. Further, the hot rolled steel sheets were successively ground down, cold rolled, and heat treated to produce cold rolled steel sheets.

Some of the obtained cold rolled steel sheets were plated. Samples taken from the obtained steel sheets were analyzed for chemical composition, whereupon it was confirmed that there were no changes from the chemical compositions of the slabs. The chemical compositions of these steel sheets are shown in Table 1. The balances besides the constituents shown in Table 1 are Fe and impurities. It should be noted that, for plated steel sheets, the chemical compositions are those of the base steel sheets with the plating layers at the surfaces peeled off under the above conditions. The underlines attached to the chemical compositions in Table 1 show values outside the scope of the present invention.

TABLE 1

| Steel | Chemical composition (mass %, bal.: Fe and impurities) | | | | | | | | | | |
|---|---|---|---|---|---|---|---|---|---|---|---|
| type | C | Si | Mn | Al | Ti | B | P | S | N | O | Cr |
| A | 0.21 | 0.46 | 2.28 | 0.803 | 0.025 | 0.0018 | 0.012 | 0.0007 | 0.004 | 0.0012 | |
| B | 0.22 | 0.87 | 2.67 | 0.591 | 0.023 | 0.0021 | 0.018 | 0.0013 | 0.004 | 0.0015 | |
| C | 0.27 | 0.81 | 3.03 | 0.547 | 0.028 | 0.0015 | 0.011 | 0.0019 | 0.004 | 0.0010 | |
| D | 0.16 | 0.73 | 2.51 | 0.712 | 0.021 | 0.0019 | 0.012 | 0.0010 | 0.002 | 0.0014 | |
| E | 0.20 | 1.15 | 2.43 | 0.544 | 0.019 | 0.0020 | 0.020 | 0.0006 | 0.004 | 0.0008 | |
| F | 0.34 | 0.66 | 2.79 | 0.525 | 0.022 | 0.0011 | 0.005 | 0.0013 | 0.002 | 0.0011 | 0.33 |
| G | 0.23 | 0.15 | 2.56 | 0.868 | 0.032 | 0.0025 | 0.008 | 0.0012 | 0.004 | 0.0014 | |
| H | 0.24 | 0.72 | 2.60 | 0.316 | 0.016 | 0.0030 | 0.009 | 0.0012 | 0.003 | 0.0022 | |
| I | 0.24 | 0.88 | 3.45 | 0.609 | 0.02 | 0.0006 | 0.016 | 0.0019 | 0.003 | 0.0021 | |
| J | 0.26 | 0.75 | 1.33 | 0.493 | 0.024 | 0.0017 | 0.019 | 0.0012 | 0.002 | 0.0009 | 0.80 |
| K | 0.17 | 0.40 | 2.88 | 1.336 | 0.042 | 0.0013 | 0.016 | 0.0018 | 0.005 | 0.0020 | |
| L | 0.13 | 0.95 | 2.41 | 0.638 | 0.027 | 0.0020 | 0.008 | 0.0012 | 0.004 | 0.0017 | |
| M | 0.38 | 0.80 | 2.56 | 0.561 | 0.03 | 0.0013 | 0.018 | 0.0023 | 0.004 | 0.0021 | |
| N | 0.21 | 1.59 | 2.33 | 0.358 | 0.021 | 0.0011 | 0.017 | 0.0011 | 0.003 | 0.0020 | |
| O | 0.23 | 0.75 | 0.93 | 0.509 | 0.023 | 0.0019 | 0.010 | 0.0023 | 0.004 | 0.0022 | |
| P | 0.18 | 0.74 | 4.18 | 0.606 | 0.024 | 0.0020 | 0.012 | 0.0019 | 0.003 | 0.0010 | |
| Q | 0.18 | 0.63 | 2.96 | 0.130 | 0.033 | 0.0019 | 0.018 | 0.0024 | 0.004 | 0.0009 | |
| R | 0.20 | 0.52 | 2.41 | 1.661 | 0.017 | 0.0024 | 0.018 | 0.0024 | 0.004 | 0.0009 | |
| S | 0.23 | 0.81 | 2.85 | 0.703 | 0.033 | 0.0002 | 0.018 | 0.0024 | 0.004 | 0.0009 | |

| | | | | | | | | | | | Ac1 |
|---|---|---|---|---|---|---|---|---|---|---|---|
| Steel | Chemical composition (mass %, bal.: Fe and impurities) | | | | | | | | | | point |
| type | Mo | Cu | Ni | Co | W | Sn | Sb | Nb | V | Others | (° C.) |
| A | | | | | | | | | | | 712 |
| B | 0.11 | | | | | | | | | | 720 |
| C | 0.29 | | | | | | | 0.019 | | | 714 |
| D | | | | | | 0.21 | 0.05 | | | | 717 |
| E | | 0.33 | 0.15 | | | | | | | | 728 |
| F | | | | | | | | | 0.260 | | 718 |
| G | | | | | | | | | | As: 0.06 | 700 |
| H | | | | 0.33 | | | | | | Ca: 0.0047, | 716 |
| | | | | | | | | | | Mg: 0.0056 | |
| I | | | | | 0.45 | | | | | Zr: 0.0050, | 712 |
| | | | | | | | | | | Hf: 0.0033 | |
| J | 0.25 | | | | | | | | | Zn: 0.13 | 744 |
| K | | | 0.63 | | | | | | | Bi: 0.0045, | 693 |
| | | | | | | | | | | REM: 0.011 | |
| L | | | | | | | | | | | 725 |
| M | | | | | | | | | | | 719 |
| N | | | | | | | | | | | 744 |
| O | | | | | | | | | | | 735 |
| P | | | | | | | | | | | 700 |
| Q | | | | | | | | | | | 710 |
| R | | | | | | | | | | | 712 |
| S | | | | | | | | | | | 716 |

TABLE 2

| | | Hot rolling step: Step (a) | | | | | | | | | | | |
|---|---|---|---|---|---|---|---|---|---|---|---|---|---|
| | | | Finish rolling | | | | | | | | | | |
| | | | R1 | | | | | | | | | | |
| | | Slab | entry | | | | | | | R3 exit | | Heat | 500 to |
| | | heating | side | | | | | | | side | Coiling | ins./ | 650° C. |
| | Steel | temp. | temp | R1 | t1 | R2 | t2 | R3 | t3 | temp. | temp. | retention | time |
| No. | type | ° C. | ° C. | % | sec | % | sec | % | sec | ° C. | ° C. | ° C. | h |
| 1 | A | 1232 | 940 | 25 | 0.6 | 24 | 0.5 | 22 | 1.6 | 918 | 572 | Yes | 2.5 |
| 2 | A | 1225 | 962 | 30 | 0.8 | 27 | 0.8 | 25 | 1.0 | 920 | 586 | Yes | 3.0 |
| 3 | A | 1279 | 937 | 26 | 0.9 | 23 | 0.3 | 21 | 2.2 | 898 | 603 | Yes | 3.3 |
| 4 | A | 1204 | 972 | 26 | 0.9 | 22 | 0.7 | 25 | 1.9 | 921 | 596 | No | — |
| 5 | A | 1251 | 934 | 24 | 0.7 | 27 | 0.9 | 21 | 2.3 | 892 | 423 | No | — |
| 6 | A | 1265 | 964 | 24 | 0.3 | 15 | 0.8 | 14 | 1.4 | 926 | 549 | Yes | 4.0 |
| 7 | A | 1250 | 975 | 22 | 1.5 | 23 | 1.5 | 21 | 2.2 | 906 | 561 | Yes | 2.2 |
| 8 | A | 1223 | 991 | 27 | 0.5 | 21 | 0.9 | 24 | 1.4 | 968 | 583 | Yes | 3.1 |
| 9 | A | 1251 | 1013 | 24 | 0.7 | 20 | 0.9 | 21 | 2.3 | 945 | 526 | Yes | 3.0 |
| 10 | A | 1257 | 957 | 28 | 0.9 | 21 | 0.8 | 20 | 2.3 | 914 | 492 | Yes | 3.5 |
| 11 | A | 1268 | 968 | 29 | 0.5 | 22 | 0.4 | 25 | 2.2 | 936 | 588 | Yes | 2.9 |
| 12 | A | 1252 | 970 | 21 | 0.9 | 27 | 0.7 | 25 | 1.4 | 910 | 569 | Yes | 3.7 |
| 13 | A | 1230 | 965 | 24 | 0.9 | 22 | 0.9 | 25 | 1.0 | 915 | 511 | Yes | 2.0 |
| 14 | A | 1276 | 971 | 29 | 0.4 | 26 | 0.4 | 25 | 1.0 | 920 | 557 | Yes | 2.6 |
| 15 | A | 1230 | 935 | 29 | 0.9 | 24 | 0.6 | 21 | 1.2 | 885 | 601 | Yes | 4.3 |
| 16 | A | 1246 | 954 | 23 | 0.8 | 26 | 0.6 | 23 | 1.8 | 903 | 610 | Yes | 2.2 |
| 17 | A | 1202 | 965 | 20 | 0.5 | 26 | 0.7 | 24 | 1.7 | 905 | 523 | Yes | 3.6 |
| 18 | B | 1202 | 973 | 30 | 0.5 | 22 | 0.9 | 25 | 1.0 | 934 | 545 | Yes | 3.4 |
| 19 | B | 1222 | 952 | 30 | 0.6 | 22 | 0.7 | 25 | 1.5 | 920 | 591 | Yes | 4.4 |
| 20 | B | 1200 | 959 | 21 | 0.5 | 22 | 0.6 | 20 | 1.3 | 926 | 488 | Yes | 5.6 |
| 21 | B | 1209 | 963 | 20 | 0.7 | 22 | 0.6 | 21 | 2.0 | 932 | 556 | Yes | 6.3 |
| 22 | C | 1220 | 971 | 22 | 0.8 | 21 | 0.8 | 24 | 2.1 | 928 | 594 | Yes | 5.1 |
| 23 | C | 1232 | 935 | 29 | 0.7 | 26 | 0.6 | 24 | 1.4 | 878 | 564 | Yes | 5.8 |
| 24 | C | 1225 | 932 | 25 | 0.5 | 22 | 0.7 | 23 | 1.1 | 896 | 516 | Yes | 5.8 |
| 25 | D | 1247 | 955 | 26 | 0.6 | 23 | 0.5 | 21 | 1.5 | 913 | 509 | Yes | 1.6 |
| 26 | E | 1278 | 967 | 22 | 0.7 | 20 | 0.5 | 21 | 2.4 | 937 | 510 | Yes | 6.0 |
| 27 | F | 1232 | 940 | 23 | 0.3 | 20 | 0.3 | 25 | 2.5 | 904 | 554 | Yes | 10.0 |
| 28 | G | 1276 | 935 | 29 | 0.5 | 24 | 0.5 | 21 | 1.5 | 877 | 550 | Yes | 3.2 |
| 29 | H | 1244 | 965 | 23 | 0.5 | 27 | 0.9 | 22 | 1.3 | 925 | 585 | Yes | 4.0 |
| 30 | I | 1205 | 971 | 23 | 0.5 | 24 | 0.5 | 25 | 2.5 | 935 | 500 | Yes | 8.3 |
| 31 | J | 1206 | 950 | 30 | 0.8 | 22 | 0.9 | 25 | 1.1 | 891 | 582 | Yes | 2.0 |
| 32 | K | 1236 | 942 | 30 | 0.6 | 26 | 0.8 | 24 | 2.4 | 896 | 598 | Yes | 4.8 |
| 33 | L | 1207 | 963 | 25 | 0.6 | 24 | 0.4 | 25 | 2.1 | 930 | 555 | Yes | 3.6 |
| 34 | M | 1226 | 933 | 26 | 0.4 | 23 | 0.5 | 25 | 1.0 | 878 | 524 | Yes | 3.3 |
| 35 | N | 1272 | 937 | 20 | 0.6 | 25 | 0.9 | 25 | 2.3 | 879 | 602 | Yes | 2.7 |
| 36 | O | 1264 | 968 | 23 | 0.3 | 27 | 0.6 | 21 | 1.0 | 919 | 577 | Yes | 5.0 |
| 37 | P | 1239 | 933 | 22 | 0.8 | 23 | 0.7 | 22 | 2.0 | 889 | 536 | Yes | 4.3 |
| 38 | Q | 1239 | 955 | 26 | 0.9 | 23 | 0.3 | 23 | 1.1 | 907 | 589 | Yes | 3.7 |
| 39 | R | 1259 | 952 | 27 | 0.3 | 21 | 0.9 | 24 | 1.9 | 916 | 555 | Yes | 2.8 |
| 40 | S | 1215 | 939 | 29 | 0.7 | 27 | 0.5 | 22 | 1.8 | 899 | 593 | Yes | 5.3 |

The hot rolling was performed under the conditions described in Table 2. In Table 2, the “R1 entry side temperature” means the entry side steel sheet temperature of the third pass counted from the final pass of the finish rolling. “R1” means the rolling reduction of the third pass counted from the final pass. R2 means the rolling reduction of the second pass counted from the final pass. R3 means the rolling reduction of the final pass. Further, t1 means the time from the end of the third pass counted from the final pass to the start of the second pass counted from the final pass. t2 means the time from the end of the second pass counted from the final pass to the start of the final pass. t3 means the time from the end of the final pass to the start of the cooling. Further, the R3 exit side temperature means the temperature of the steel sheet at the time of the end of the final pass, that is, the finish rolling completion temperature.

After that, a rotary grinding brush containing abrasives was used to grind the front and back surfaces of the hot rolled steel sheet. The grinding conditions are found from a rotational speed R (rpm) of the grinding brush, diameter D (m) of the grinding brush, and running speed V (m/min) of the steel sheet. They were set so that the value of (R·D)/V became the values shown in Table 3. Next, the ground steel sheet was pickled. Further, the pickled steel sheet was cold rolled by the rolling reduction described in Table 3. The sheet thickness after cold rolling was 1.4 mm in all cases.

After that, the cold rolled steel sheet was heat treated. The heat treatment comprised heating up to the maximum heating temperature, then holding it there and cooling. The sheet was cooled down to the Ms point−30° C. or less in temperature, then holding at 300 to 450° C. The values of these conditions and the value of the log(pH₂O/pH₂) from 650° C. to the maximum heating temperature are shown in Table 3. In this case, pH₂O is the steam partial pressure, while pH₂ is the hydrogen partial pressure. Further, in Table 3, Ms is the martensite transformation point (° C.) of the steel used.

It should be noted that, in Table 3, the Ac1 point (° C.), which is the standard for the setting range of the maximum heating temperature of the heat treatment, was found in accordance with the following formula. The Ac1 points of the steel sheets are shown in Table 1.

$$Ac 1 = 723 - 10.7 [ Mn ] - 16.9 [ Ni ] + 29.1 [ Si ] + 16.9 [ Cr ]$$

In the above formula, [Mn], [Ni], [Si], and [Cr] mean the contents (mass %) of the elements.

Further, in Table 3, the Ms point (° C.) is found in accordance with the following formula:

$$Ms = 561 - 474 [ C ] - 33 [ Mn ] - 7.5 [ Si ] - 17 [ Cr ] - 17 [ Ni ] - 21 [ Mo ] + 10 [ Co ]$$

In the above formula, [C], [Mn], [Si], [Cr], [Ni], [Mo], and [Co] mean the contents (mass %) of the elements.

After that, some of the steel sheets were continuously hot dip galvanized and further some were alloyed. The plating conditions were not special ones and could be known general conditions. In Table 3, “GA” means hot dip galvannealed steel sheet. Further, “GI” means hot dip galvanized steel sheet hot dip galvanized steel sheet which has not been alloyed. “CR” means cold rolled steel sheet which has not been plated.

It should be noted that, the underlines attached to the various numerical values in Table 2 and Table 3 show outside the scope of the present invention, production conditions not yielding the steel sheet of the present invention, or various properties of steel sheet which are not preferable.

TABLE 3

| | | Cold | Heat treatment step: step (d) | | | | | | | | | |
|---|---|---|---|---|---|---|---|---|---|---|---|---|
| | | rolling | | | | Holding | Average | | | | | |
| | Grinding | step: | | | | time at | cooling | | Holding | Holding | | |
| | step: | step (c) | | Max. | | max. | speed from | Cooling | temp. at | time. at | | |
| | step (e) | Rolling | Heating | heating | log(pH₂O/ | heating | 700° C. to | end | 300 to | 300 to | Ms | |
| | (R · D)/ | reduction | speed | temp. | pH₂) | temp. | 500° C. | temp. | 450° C. | 450° C. | point | |
| No. | V | % | ° C./s | ° C. | — | sec | ° C./s | ° C | ° C. | sec | ° C. | Grade |
| 1 | 19 | 60 | 2.0 | 836 | −0.6 | 96 | 53 | 252 | 368 | 454.0 | 383 | CR |
| 2 | 22 | 60 | 2.1 | 840 | −2.1 | 130 | 39 | 241 | 377 | 408.0 | 383 | CR |
| 3 | None | 60 | 2.1 | 845 | −0.6 | 85 | 45 | 269 | 410 | 356.0 | 383 | CR |
| 4 | 20 | 60 | 2.0 | 838 | −0.7 | 119 | 50 | 238 | 379 | 420.0 | 383 | CR |
| 5 | 16 | 60 | 2.2 | 853 | −0.6 | 92 | 53 | 219 | 406 | 360.0 | 383 | CR |
| 6 | 27 | 60 | 1.8 | 851 | −0.7 | 95 | 22 | 275 | 394 | 416.0 | 383 | CR |
| 7 | 23 | 60 | 2.3 | 857 | −0.6 | 91 | 56 | 244 | 383 | 301.0 | 383 | CR |
| 8 | 26 | 60 | 2.9 | 869 | −0.6 | 100 | 71 | 262 | 400 | 328.0 | 383 | CR |
| 9 | 16 | 60 | 2.0 | 838 | −0.8 | 103 | 54 | 250 | 395 | 337.0 | 383 | CR |
| 10 | 16 | 60 | 1.3 | 757 | −0.7 | 106 | 54 | 68 | 407 | 347.0 | 383 | CR |
| 11 | 17 | 60 | 2.0 | 834 | −0.8 | 101 | 69 | 247 | 270 | 303.0 | 383 | CR |
| 12 | 19 | 60 | 2.4 | 847 | −0.7 | 99 | 51 | 229 | 387 | 50.0 | 383 | CR |
| 13 | 6 | 60 | 2.3 | 842 | −0.7 | 105 | 37 | 230 | 396 | 399.0 | 383 | CR |
| 14 | 20 | 60 | 2.0 | 833 | −0.5 | 130 | 7 | 246 | 401 | 419.0 | 383 | CR |
| 15 | 15 | 60 | 2.0 | 834 | −0.7 | 88 | 46 | 240 | 478 | 352.0 | 383 | CR |
| 16 | 20 | 60 | 2.5 | 849 | −0.6 | 85 | 25 | 205 | 384 | 159.0 | 383 | GA |
| 17 | 23 | 60 | 2.5 | 851 | −0.6 | 93 | 23 | 209 | 392 | 176.0 | 383 | GI |
| 18 | 15 | 53 | 2.3 | 845 | −0.7 | 81 | 40 | 220 | 385 | 198.0 | 360 | CR |
| 19 | 13 | 53 | 2.3 | 839 | −0.7 | 88 | 26 | 373 | 377 | 259.0 | 360 | CR |
| 20 | 15 | 53 | 2.4 | 840 | −0.6 | 77 | 24 | 227 | 404 | 151.0 | 360 | GA |
| 21 | 14 | 53 | 2.4 | 844 | −0.6 | 81 | 28 | 215 | 399 | 155.0 | 360 | GI |
| 22 | 26 | 46 | 3.1 | 889 | −0.7 | 105 | 33 | 212 | 324 | 331.0 | 321 | CR |
| 23 | 18 | 46 | 3.3 | 896 | −0.5 | 90 | 21 | 204 | 337 | 141.0 | 321 | GA |
| 24 | 15 | 46 | 3.0 | 891 | −0.6 | 90 | 23 | 209 | 335 | 105.0 | 321 | GI |
| 25 | 23 | 53 | 2.7 | 861 | −0.7 | 118 | 48 | 159 | 318 | 113.0 | 397 | CR |
| 26 | 21 | 53 | 2.5 | 853 | −0.5 | 88 | 56 | 244 | 401 | 175.0 | 375 | CR |
| 27 | 25 | 53 | 2.9 | 876 | −0.6 | 60 | 89 | 168 | 352 | 375.0 | 297 | CR |
| 28 | 15 | 53 | 3.0 | 870 | −0.7 | 103 | 42 | 166 | 330 | 209.0 | 366 | CR |
| 29 | 17 | 53 | 2.5 | 855 | −0.6 | 137 | 30 | 192 | 373 | 137.0 | 359 | CR |
| 30 | 16 | 53 | 3.4 | 897 | −0.8 | 98 | 16 | 180 | 321 | 236.0 | 327 | CR |
| 31 | 20 | 53 | 2.8 | 862 | −0.7 | 182 | 50 | 275 | 378 | 146.0 | 369 | CR |
| 32 | 21 | 53 | 5.3 | 904 | −0.3 | 100 | 65 | 217 | 352 | 208.0 | 372 | CR |
| 33 | 21 | 53 | 4.0 | 890 | −0.7 | 91 | 54 | 245 | 333 | 180.0 | 413 | CR |
| 34 | 27 | 53 | 2.5 | 851 | −0.7 | 109 | 25 | 200 | 405 | 253.0 | 290 | CR |
| 35 | 14 | 53 | 2.2 | 839 | −0.7 | 87 | 29 | 238 | 394 | 390.0 | 373 | CR |
| 36 | 18 | 53 | 2.8 | 865 | −0.6 | 156 | 61 | 101 | 389 | 311.0 | 416 | CR |
| 37 | 25 | 53 | 2.3 | 842 | −0.7 | 76 | 40 | 215 | 375 | 468.0 | 332 | CR |
| 38 | 21 | 53 | 2.1 | 830 | −0.8 | 85 | 58 | 224 | 394 | 150.0 | 373 | CR |
| 39 | 20 | 53 | 4.9 | 900 | −0.7 | 120 | 39 | 165 | 388 | 375.0 | 383 | CR |
| 40 | 15 | 53 | 3.2 | 879 | −0.7 | 79 | 63 | 207 | 370 | 303.0 | 352 | CR |

The obtained steel sheets were measured for emission intensities of B of B30, B140, and B150 at the different depth positions of 30 μm, 140 μm, and 150 μm from the steel sheet surface when using the method of the above-mentioned high frequency glow discharge spectrometry (high frequency GDS analysis) for measurement by the above-mentioned high frequency GDS analysis in the sheet thickness direction from the steel sheet surface. Simultaneously the emission intensities of C of C30, C140, and C150 at the different depth positions of 30 μm, 140 μm, and 150 μm from the steel sheet surface were measured. These measurement results are shown in the following Table 4.

Further, from the center part of width of each obtained steel sheet, a No. 5 tensile test piece of JIS Z 2241: 2011 having a direction perpendicular to the rolling direction as its longitudinal direction was taken and that test piece was used to perform a tensile test based on JIS Z2241: 2011 to measure the tensile strength (TS) and elongation (EL). It should be noted that, regarding the No. 30 and No. 31 steel sheets, the tensile strength as plated was measured without peeling off the plating from the plated steel sheets. In the present embodiment, the basis of the tensile strength (980 MPa or more) was made the same as the steel sheet which was not plated. The balance of the tensile strength and elongation was judged to be good if TS^{1.5} xEL/1000 was 440 or more. These results are shown in the following Table 4.

Further, from the center part of width of each obtained steel sheet, a tensile test piece of a parallel part width of 30 mm having a direction perpendicular to the rolling direction as its longitudinal direction was taken. 2% prestrain was imparted, then a rectangular sample of a width 30 mm×length 60 mm was taken from the parallel part. Next, to simulate a painting and baking step of an automobile, heat treatment was performed at 170° C. for 20 minutes. The heat treated test piece was subjected to a bending test by the method prescribed in the Verband der Automobilindustrie (VDA) standard 238-100 to measure the maximum bending angle. Regarding the measurement results, a maximum bending angle of 60 degrees or more was judged excellent in bendability. The bending direction was determined so that the rolling direction became parallel to the bending ridgeline. It should be noted that, in the No. 30 and No. 31 steel sheets, the maximum bending angle as plated was measured without peeling off the plating from the plated steel sheet. In this embodiment, the basis of the maximum bending angle (60 degrees or more) is made the same as steel sheet not formed with a plating. The results of measurement of the maximum bending angles of the steel sheets are shown in the following Table 4.

Further, to evaluate the liquid metal embrittlement (LME) cracking resistance of the spot welded parts, a 150 mm width×50 mm length test piece was taken from each of the obtained steel sheets and subjected to a spot welding test in sets of two. Each set of sheets was comprised of the two sheets of a steel sheet shown in Table 3 and a commercially available hot dip galvannealed steel sheet (SGCC: JIS G 3346, amount of plating deposition of 60 g/m², sheet thickness 1.4 mm). These were welded in a state given a weld angle of 5 degrees. For the tester, a servo motor driven stationary type spot weld tester was used. The power supply was made a single-phase alternating current 50 Hz, the squeezing force was made 400 kg, the weld time was made 20 cycles, and the holding time was made 5 cycles. The weld current value was made a current value yielding a diameter of the weld nugget of 4.0 times, 4.5 times, 5.0 times, and 5.5 times the √t (t: sheet thickness/mm). For the electrodes, chrome copper electrodes with a tip diameter of φ6 mm and a radius of curvature R of the tip of 40 mm were used. The sample after welding was examined for cross-section of the nugget part. In the examination of the cross-section, samples with 0.2 mm or more cracks observed at any of the above weld current values were judged as “POOR” while ones with 0.1 to less than 0.2 mm cracks observed at any of the above weld currents were judged as “GOOD”. One with no 0.1 mm or more cracks observed at any of the above weld currents were judged as “EX”. The results of evaluation of the LME cracking resistance of the different steel sheets are shown in the following Table 4.

In this case, the points to note in the evaluation of the present invention will be explained. The features of the present invention, that is, the chemical composition, microstructure, B concentration distribution, C concentration distribution, and other features of the steel sheet, are prescribed for regions unrelated to any surface covering. On the other hand, the mechanical properties of steel sheet are generally believed to change somewhat depending on any surface covering. Even under such a situation, in the present invention, steel sheet of the same surface conditions as the point of time of use of the steel sheet is used to judge whether the mechanical properties of the steel sheet fall in the scope of the present invention. This is because for a person using steel sheet with a covered surface, not the mechanical properties of the state with the covering peeled off, but the mechanical properties in the covered state are important. Accordingly, in the invention examples, plated steel sheets (No. 16, 17, 20, 21, 23, and 24 steel sheets) are evaluated for the mechanical properties of tensile strength, elongation, and bendability (maximum bending angle and load drop) in the state as plated while not plated steel sheets (steel sheets other than No. 16, 17, 20, 21, 23, and 24) are evaluated in the non-plated state.

It should be noted that, in Table 4, “α” of the microstructure means ferrite. Further, “γ” means retained austenite. “FM+θ” means the total of fresh martensite and cementite. “P” means pearlite. “TM” means tempered martensite. Further, “B” means bainite.

In Table 4, the underlines attached to the various numerical values etc. indicate outside the scope of the present invention, production conditions not giving the steel sheet of the present invention, or various properties of the steel sheet which are not preferable.

TABLE 4

| | | | | | | | | | | | | Mechanical properties | | | | | |
|---|---|---|---|---|---|---|---|---|---|---|---|---|---|---|---|---|---|
| | | Microstructure | | | | | | Surface | | | | Tensile | | | Max. | | |
| | | | | FM + | | | | B30/ | C30/ | B140/ | C140/ | strength | Elongation | TS^{1.5} × | bending | LME | |
| | Steel | α | γ | θ | P | TM | B | B150 | C150 | B150 | C150 | (TS) | (EL) | EL/1000 | angle | cracking | |
| No. | type | % | % | % | % | % | % | — | — | — | — | MPa | % | — | ° | resist. | Remarks |
| 1 | A | 32 | 12 | 3 | 0 | 38 | 15 | 0.42 | 0.33 | 0.99 | 0.98 | 1008 | 21 | 678 | 98 | EX | Inv. ex. |
| 2 | A | 26 | 11 | 3 | 0 | 43 | 17 | 0.40 | 0.96 | 0.98 | 0.99 | 1013 | 21 | 664 | 85 | POOR | Comp. ex. |
| 3 | A | 21 | 11 | 2 | 0 | 35 | 31 | 0.94 | 0.31 | 0.96 | 1.01 | 998 | 22 | 697 | 57 | EX | Comp. ex. |
| 4 | A | 30 | 10 | 3 | 0 | 39 | 18 | 0.67 | 0.43 | 1.00 | 0.97 | 1022 | 21 | 686 | 76 | EX | Inv. ex. |
| 5 | A | 22 | 12 | 2 | 0 | 45 | 19 | 0.92 | 0.46 | 1.02 | 0.96 | 1037 | 20 | 668 | 52 | EX | Comp. ex. |
| 6 | A | 25 | 11 | 4 | 0 | 32 | 28 | 0.96 | 0.40 | 0.97 | 0.99 | 986 | 22 | 678 | 55 | EX | Comp. ex. |
| 7 | A | 20 | 11 | 3 | 0 | 33 | 33 | 0.93 | 0.38 | 1.03 | 0.96 | 1035 | 20 | 669 | 56 | EX | Comp. ex. |
| 8 | A | 13 | 10 | 2 | 0 | 50 | 25 | 0.95 | 0.45 | 1.01 | 0.99 | 1031 | 20 | 646 | 58 | EX | Comp. ex. |
| 9 | A | 27 | 11 | 2 | 0 | 38 | 22 | 0.95 | 0.44 | 0.97 | 0.98 | 1024 | 21 | 678 | 54 | EX | Comp. ex. |
| 10 | A | 61 | 9 | 8 | 0 | 15 | 7 | 0.39 | 0.38 | 1.00 | 1.03 | 924 | 19 | 528 | 68 | EX | Comp. ex. |
| 11 | A | 30 | 4 | 19 | 0 | 34 | 13 | 0.40 | 0.42 | 0.97 | 0.99 | 1057 | 12 | 419 | 51 | EX | Comp. ex. |
| 12 | A | 21 | 4 | 22 | 0 | 39 | 14 | 0.33 | 0.37 | 1.01 | 1.00 | 1096 | 11 | 410 | 49 | EX | Comp. ex. |
| 13 | A | 23 | 12 | 2 | 0 | 44 | 19 | 0.93 | 0.44 | 0.96 | 1.01 | 1000 | 22 | 705 | 55 | EX | Comp. ex. |
| 14 | A | 60 | 12 | 3 | 0 | 12 | 13 | 0.35 | 0.30 | 0.99 | 1.00 | 933 | 21 | 607 | 70 | EX | Comp. ex. |
| 15 | A | 31 | 5 | 5 | 6 | 30 | 23 | 0.38 | 0.34 | 0.96 | 0.94 | 945 | 15 | 436 | 52 | EX | Comp. ex. |
| 16 | A | 24 | 12 | 2 | 0 | 43 | 19 | 0.41 | 0.33 | 1.01 | 1.00 | 1011 | 22 | 717 | 91 | EX | Inv. ex. |
| 17 | A | 22 | 12 | 2 | 0 | 40 | 24 | 0.39 | 0.34 | 1.00 | 0.97 | 1005 | 23 | 720 | 91 | EX | Inv. ex. |
| 18 | B | 11 | 11 | 1 | 0 | 59 | 18 | 0.47 | 0.29 | 1.00 | 0.94 | 1227 | 16 | 683 | 85 | EX | Inv. ex. |
| 19 | B | 16 | 12 | 17 | 0 | 0 | 55 | 0.40 | 0.34 | 1.00 | 0.96 | 1154 | 17 | 651 | 50 | EX | Comp. ex. |
| 20 | B | 12 | 11 | 2 | 0 | 58 | 17 | 0.40 | 0.41 | 0.97 | 1.01 | 1211 | 16 | 674 | 93 | EX | Inv. ex. |
| 21 | B | 12 | 10 | 2 | 0 | 63 | 13 | 0.39 | 0.36 | 0.99 | 1.00 | 1222 | 16 | 666 | 95 | EX | Inv. ex. |
| 22 | C | 0 | 9 | 5 | 0 | 86 | 0 | 0.44 | 0.35 | 0.92 | 0.99 | 1489 | 11 | 609 | 72 | EX | Inv. ex. |
| 23 | C | 0 | 9 | 5 | 0 | 86 | 0 | 0.41 | 0.38 | 0.95 | 0.99 | 1501 | 11 | 611 | 77 | EX | Inv. ex. |
| 24 | C | 0 | 9 | 4 | 0 | 87 | 0 | 0.40 | 0.37 | 0.99 | 1.00 | 1514 | 11 | 636 | 75 | EX | Inv. ex. |
| 25 | D | 29 | 7 | 3 | 0 | 41 | 20 | 0.43 | 0.34 | 0.94 | 1.02 | 1001 | 17 | 545 | 103 | EX | Inv. ex. |
| 26 | E | 13 | 14 | 4 | 0 | 52 | 17 | 0.35 | 0.37 | 0.99 | 0.91 | 1206 | 18 | 733 | 88 | GOOD | Inv. ex. |
| 27 | F | 0 | 13 | 8 | 0 | 77 | 2 | 0.41 | 0.33 | 0.98 | 0.92 | 1503 | 15 | 886 | 62 | GOOD | Inv. ex. |
| 28 | G | 22 | 7 | 3 | 0 | 40 | 28 | 0.48 | 0.30 | 0.95 | 0.91 | 998 | 17 | 520 | 100 | EX | Inv. ex. |
| 29 | H | 5 | 7 | 0 | 0 | 72 | 16 | 0.40 | 0.24 | 0.99 | 0.96 | 1212 | 13 | 532 | 91 | EX | Inv. ex. |
| 30 | I | 0 | 6 | 6 | 0 | 88 | 0 | 0.43 | 0.35 | 0.91 | 0.95 | 1509 | 10 | 574 | 65 | EX | Inv. ex. |
| 31 | J | 46 | 12 | 5 | 0 | 13 | 24 | 0.44 | 0.30 | 0.94 | 0.93 | 992 | 21 | 650 | 93 | EX | Inv. ex. |
| 32 | K | 25 | 9 | 3 | 0 | 53 | 10 | 0.41 | 0.18 | 0.92 | 0.99 | 1205 | 14 | 590 | 98 | EX | Inv. ex. |
| 33 | L | 37 | 6 | 2 | 0 | 25 | 30 | 0.43 | 0.32 | 0.93 | 0.95 | 902 | 19 | 526 | 110 | EX | Comp. ex. |
| 34 | M | 15 | 23 | 9 | 0 | 35 | 18 | 0.45 | 0.22 | 0.99 | 0.96 | 1406 | 19 | 986 | 54 | POOR | Comp. ex. |
| 35 | N | 40 | 16 | 5 | 0 | 21 | 18 | 0.38 | 0.27 | 0.92 | 1.00 | 1025 | 24 | 794 | 83 | POOR | Comp. ex. |
| 36 | O | 65 | 4 | 5 | 7 | 0 | 19 | 0.40 | 0.31 | 1.02 | 0.98 | 808 | 25 | 574 | 109 | EX | Comp. ex. |
| 37 | P | 12 | 8 | 19 | 0 | 61 | 0 | 0.47 | 0.42 | 0.91 | 1.03 | 1345 | 12 | 587 | 51 | GOOD | Comp. ex. |
| 38 | Q | 15 | 5 | 3 | 0 | 63 | 14 | 0.41 | 0.36 | 0.96 | 0.93 | 1198 | 10 | 431 | 83 | EX | Comp. ex. |
| 39 | R | 45 | 10 | 6 | 0 | 15 | 24 | 0.46 | 0.30 | 1.03 | 1.00 | 1102 | 17 | 611 | 50 | EX | Comp. ex. |
| 40 | S | 12 | 12 | 4 | 0 | 62 | 10 | — | 0.33 | — | 0.91 | 1250 | 15 | 645 | 56 | POOR | Comp. ex. |

In the No. 2 steel sheet, the log(pH₂O/pH₂) was low, became smaller than −1.0, and the decarburization reaction did not sufficiently proceed, and therefore the result was the LME cacking resistance was poor.

In the No. 3 steel sheet, brush grinding was not performed and a suitable deboronized layer was not formed, and therefore the maximum bending angle after imparting prestrain became small and the result was the bendability was poor.

In the No. 5 steel sheet, the coiling temperature was low and a suitable deboronized layer was not formed, and therefore the maximum bending angle after imparting prestrain became small and the result was the bendability was poor.

In the No. 6 steel sheet, the rolling reduction of the finish rolling in the hot rolling step was not suitable and a suitable deboronized layer was not formed, and therefore the maximum bending angle after imparting prestrain became small and the result was the bendability was poor.

In the No. 7 steel sheet, the time between passes in the finish rolling at the hot rolling step was long and a suitable deboronized layer was not formed, and therefore the maximum bending angle after imparting prestrain became small and the result was the bendability was poor.

In the No. 8 steel sheet, the finish rolling completion temperature at the hot rolling step was high and a suitable deboronized layer was not formed, and therefore the maximum bending angle after imparting prestrain became small and the result was the bendability was poor.

In the No. 9 steel sheet, the entry side steel sheet temperature before the final three passes in the hot rolling step was high and a suitable deboronized layer was not formed, and therefore the maximum bending angle after imparting prestrain became small and the result was the bendability was poor.

In the No. 10 steel sheet, the maximum heating temperature of the heat treatment step was low and the ferrite fraction became high, and therefore the desired tensile strength could not be obtained.

In the No. 11 steel sheet, the holding temperature of the step for holding at 300 to 450° C. in the heat treatment step was low, and therefore the fraction of the retained austenite became low and the total fraction of the fresh martensite and cementite became high. As a result, TS^{1.5}×EL/1000 became less than 440, the balance of tensile strength and elongation became poor as a result, and the maximum bending angle after imparting prestrain became small, therefore the result was the bendability was poor.

In the No. 12 steel sheet, the holding time at the step for holding at 300 to 450° C. in the heat treatment step was short, and therefore the fraction of the retained austenite became low, the total fraction of the fresh martensite and cementite became high, and the elongation became low. As a result, TS^{1.5}×EL/1000 became less than 440, the balance of tensile strength and elongation became poor as a result and the maximum bending angle after imparting prestrain became small, therefore the result was the bendability was poor.

In the No. 13 steel sheet, the conditions of the grinding step were not suitable and a suitable deboronized layer was not formed and the maximum bending angle after imparting prestrain became small, and therefore the result was the bendability was poor.

In No. 14 steel sheet, in the heat treatment step, the average cooling speed between 700 to 500° C. was small, and therefore the ferrite fraction became high and the desired tensile strength could not be obtained.

In No. 15 steel sheet, in the heat treatment step, the holding temperature at the step for holding a 300 to 450° C. was high, and therefore the retained austenite fraction became low, pearlite was formed, and the desired tensile strength could not be obtained. As a result, TS^{1.5}×EL/1000 became less than 440 and the balance of tensile strength and elongation became poor as a result.

In No. 19 steel sheet, the cooling end temperature in the heat treatment step became high, therefore the total fraction of the fresh martensite and cementite became high, tempered martensite was not formed, and as a result the maximum bending angle after imparting prestrain became small, and therefore the result was the bendability was poor.

In the No. 33 steel sheet, the C content of the chemical composition was low, and therefore the desired tensile strength could not be obtained.

In the No. 34 steel sheet, the C content of the chemical composition was high, and therefore the maximum bending angle after imparting prestrain was small, the bendability became poor as a result, and the LME cracking resistance also became poor as a result.

In the No. 35 steel sheet, the Si content of the chemical composition was high, and therefore the LME cracking resistance became poor as a result.

In the No. 36 steel sheet, the Mn content of the chemical composition was low, and therefore the ferrite fraction was high, the retained austenite fraction became low, pearlite was formed, tempered martensite was not formed, and as a result the desired tensile strength could not be obtained.

In the No. 37 steel sheet, the Mn content of the chemical composition was high, and therefore the total fraction of the fresh martensite and cementite became high and as a result the maximum bending angle after imparting prestrain was small and the result was the bendability was poor.

In the No. 38 steel sheet, the Al content of the chemical composition was low, and therefore the retained austenite fraction became low. As a result, TS^{1.5}×EL/1000 became less than 440 and the balance of tensile strength and elongation became poor as a result.

In the No. 39 steel sheet, the Al content of the chemical composition was high, and therefore the maximum bending angle after imparting prestrain was small and the result was the bendability was poor.

In the No. 40 steel sheet, the B content of the chemical composition was low and a suitable deboronized layer was not formed, and therefore the maximum bending angle after imparting prestrain as small, the bendability became poor as a result, and, further, the LME cracking also became poor as a result.

### REFERENCE SIGNS LIST

1. plated steel sheet
2. base steel sheet
3. plating layer
S_{d}. steel sheet surface
P_{S}. surface layer part
P_{B}. deboronized layer
P₃₀. depth position of 30 μm from steel sheet surface
P₁₅₀. depth position of 150 μm from steel sheet surface

1. A steel sheet, which comprises
a chemical composition comprising, by mass %,
C: 0.15 to 0.35%,
Si: 0.01 to 1.20%,
Mn: 1.00 to 3.50%,
Al: 0.300 to 1.500%,
Ti: 0.001 to 0.100%,
B: 0.0005 to 0.0050%,
P: 0.050% or less,
S: 0.0100% or less,
N: 0.010% or less,
O: 0.0100% or less,
Cr: 0 to 1.00%,
Mo: 0 to 1.00%,
Cu: 0 to 1.00%,
Ni: 0 to 1.00%,
Co: 0 to 1.00%,
W: 0 to 1.00%,
Sn: 0 to 1.00%,
Sb: 0 to 0.50%,
Nb: 0 to 0.200%,
V: 0 to 1.00%,
As: 0 to 0.10%,
Zn: 0 to 1.00%,
Ca: 0 to 0.0100%,
Mg: 0 to 0.0100%,
Zr: 0 to 0.0100%,
Hf: 0 to 0.0100%,
Bi: 0 to 0.0100%,
REM: 0 to 0.015%, and
balance: Fe and impurities,
a microstructure in a range of a ⅛ depth position to ⅜ depth position of sheet thickness of the steel sheet comprises, by area %,
ferrite: 0 to 50%,
retained austenite: 6 to 30%,
total of fresh martensite and cementite: 0 to 10%,
pearlite: 5% or less,
tempered martensite: 5% or more, and
balance: bainite,
a surface layer part of the steel sheet has a deboronized layer with an emission intensity of B, measured by high frequency glow discharge spectrometry in a depth direction from a steel sheet surface, satisfying following formula (1) and formula (2),
further, the surface layer part of the steel sheet has an emission intensity of C, measured by high frequency glow discharge spectrometry in the depth direction from the steel sheet surface, satisfying following formula (3) and formula (4), and
a tensile strength is 980 MPa or more:
$$B 30 / B 150 < 0 \text{.90} \qquad ( 1 )$$
$$0.9 \leq B 140 / B 150 \leq 1 \text{.10} \qquad ( 2 )$$
$$C 30 / C 150 \leq 0 \text{.50} \qquad ( 3 )$$
$$0.9 \leq C 140 / C 150 \leq 1 \text{.10} \qquad ( 4 )$$
where,
B30: emission intensity of B at depth position of 30 μm from the steel sheet surface
B140: emission intensity of B at depth position of 140 μm from the steel sheet surface
B150: emission intensity of B at depth position of 150 μm from the steel sheet surface
C30: emission intensity of C at depth position of 30 μm from the steel sheet surface
C140: emission intensity of C at depth position of 140 μm from the steel sheet surface
C150: emission intensity of C at depth position of 150 μm from the steel sheet surface.

2. The steel sheet according to claim 1, wherein a surface of the steel sheet has a hot dip galvanized layer or a hot dip galvannealed layer.

3. A method of production of steel sheet, which method of production of steel sheet comprising
a hot rolling step (a) of hot rolling a slab having a chemical composition comprising, by mass %,
C: 0.15 to 0.35%,
Si: 0.01 to 1.20%,
Mn: 1.00 to 3.50%,
Al: 0.300 to 1.500%,
Ti: 0.001 to 0.100%,
B: 0.0005 to 0.0050%,
P: 0.050% or less,
S: 0.0100% or less,
N: 0.010% or less,
O: 0.0100% or less,
Cr: 0 to 1.00%,
Mo: 0 to 1.00%,
Cu: 0 to 1.00%,
Ni: 0 to 1.00%,
Co: 0 to 1.00%,
W: 0 to 1.00%,
Sn: 0 to 1.00%,
Sb: 0 to 0.50%,
Nb: 0 to 0.200%,
V: 0 to 1.00%,
As: 0 to 0.10%,
Zn: 0 to 1.00%,
Ca: 0 to 0.0100%,
Mg: 0 to 0.0100%,
Zr: 0 to 0.0100%,
Hf: 0 to 0.0100%,
Bi: 0 to 0.0100%,
REM: 0 to 0.015%, and
balance: Fe and impurities at a 850 to 950° C. finish rolling end temperature to obtain hot rolled steel sheet, then cooling the hot rolled steel sheet down to 450 to 680° C. and coiling the hot rolled steel sheet,
a pickling step (b) of pickling the steel sheet obtained at the hot rolling step (a),
a cold rolling step (c) of cold rolling the steel sheet obtained by the pickling step (b) by a 30 to 75% rolling reduction to obtain a cold rolled steel sheet,
a heat treatment step (d) of heat treating the steel sheet obtained at the cold rolling step (c), and
a grinding step (e), before or after the pickling step (b), of using a rotary type grinding brush containing an abrasive to grind front and back surfaces of the steel sheet obtained at the hot rolling step (a) or the steel sheet obtained at the pickling step (b),
in the hot rolling step (a), finish rolling comprises three passes or more, a rolling reduction of respective passes of final three passes of the finish rolling is 20% or more, a time between passes is within 1 second, an entry side steel sheet temperature before the final three passes is 1000° C. or less, and a time from completion of a final pass to start of cooling is within 3 seconds,
in the grinding step (e), a rotational speed R (rpm) of the grinding brush, a diameter D (m) of the grinding brush, and a running speed V (m/min) of the steel sheet satisfy the following formula (5),
the heat treatment step (d) further provided with
a step (d-1) of heating the steel sheet obtained at the cold rolling step (c) from 650° C. to a maximum heating temperature of Ac1+50° C. or more and 950° C. or less by a 0.5 to 500° C./s average heating speed,
a step (d-2) of holding the steel sheet obtained at the cold rolling step (c) at the maximum heating temperature for 1 second to 300 seconds,
a step (d-3) of cooling the steel sheet obtained at the cold rolling step (c) down to Ms point−30° C. or less, at which step, cooling from 700° C. to 500° C. by a 10° C./s or more average cooling speed, and
a step (d-4) of holding the steel sheet obtained at the cold rolling step (c) at 300 to 450° C. for 100 to 600 seconds,
at step (d-1), an atmosphere in surroundings of the steel sheet obtained at the cold rolling step (c) having a steam partial pressure pH₂O and hydrogen partial pressure pH₂ satisfying a following formula (6):
$$[ Mathematical 1 ]$$
$$\frac{R \cdot D}{V} > 10 \qquad ( 5 )$$
$$- 1. \leq log ( {pH}_{2} O / {pH}_{2} ) \leq - 0.1 . \qquad ( 6 )$$

4. The method of production of steel sheet according to claim 3, wherein
the hot rolling step (a) further comprises a step of retaining a heat of the hot rolled steel sheet after coiling within 30 minutes in a heat insulating vessel with inside walls covered by a heat insulating material, wherein
a peak temperature of an atmospheric temperature inside of the heat insulating vessel is 500 to 650° C., and a time from the atmospheric temperature to the peak temperature is 1 to 8 hours.
